(19) United States
(12) Patent Application Publication
(10) Pub. No.: US 2024/0058800 A1
(43) Pub. Date: Feb. 22, 2024

(54) HABER-BOSCH CATALYST COMPRISING AN ANION-VACANT LATTICE

(71) Applicant: THE UNIVERSITY OF WARWICK, Coventry (GB)

(72) Inventors: Shanwen Tao, Coventry (GB); John Humphreys, Coventry (GB)

(21) Appl. No.: 18/498,026

(22) Filed: Oct. 30, 2023

Related U.S. Application Data
(62) Division of application No. 17/050,313, filed on Oct. 23, 2020.

(30) Foreign Application Priority Data
Apr. 24, 2018 (GB) 1806687.8
Feb. 4, 2019 (GB) 1901530.4

(51) Int. Cl. B01J 27/24; B01J 23/10; B01J 23/745; B01J 23/755; B01J 23/78; C01C 1/04

(52) U.S. Cl. CPC B01J 27/24; B01J 23/10; B01J 23/745; B01J 23/755; B01J 23/78; C01C 1/0411

(57) ABSTRACT

A composition for catalysis of a Haber-Bosch process to produce ammonia; a process employing the composition and an anion vacant lattice for use in the process.

The composition comprises an anion vacant lattice and a Haber-Bosch catalyst (e.g. Fe or Ru). Suitable anion vacant lattices include oxynitrides and oxides, which may be doped or undoped, including

CeₐM_{b}O₂₋ₓN_{y} (Formula III)

M is one or more elements with a valence lower than 4. “a” and “b” are independently in the range 0.05 to 0.95, with the proviso that “a” and “b” together sum to 1 (approximately). X is greater than 0 and less than 2. Y is greater than zero and less than or equal to X.

### FIELD OF INVENTION

The invention relates to catalysts for the Haber-Bosch process. In particular, catalytic compositions, cartridges comprising said compositions, the use of said compositions in catalysing the production of ammonia in the Haber-Bosch process, and a Haber-Bosch process wherein said composition is provided as a catalyst.

### BACKGROUND

The Haber-Bosch process is one of the most important chemical reactions discovered in the 20th century. Ammonia, the foundation of nearly all chemically useful nitrogen-containing compounds, is produced from a mixture of hydrogen gas and relatively inert nitrogen gas by means of a metal catalyst. The importance of the Haber-Bosch process is underlined by the Nobel Prizes in chemistry awarded to both its pioneers after whom the process is named.

Hydrogen gas and nitrogen gas are combined in a pressurised vessel and heated. In the presence of a suitable catalyst, the hydrogen and nitrogen molecules react at the surface of the catalyst to form ammonia which is then desorbed from the catalyst.

The precise mechanism by which the reaction proceeds is not completely known but it is believed, without being bound by theory that nitrogen gas molecules adsorb on the catalyst surface and dissociate to form highly reactive nitrogen species that are more capable of reacting with hydrogen gas molecules.

Numerous catalysts have been investigated and many modifications to the technique have been proposed over the last 100 years. For example, co-catalytic materials have been tested in combination with traditional Haber-Bosch catalysts in an attempt to augment the catalytic activity. Examples include K₂O, CaO, Cs₂O, and Al₂O₃. Various systems have also been proposed to maximise the surface area of catalyst materials to increase reaction rates.

Attempts have been made to move away from the conventional Haber-Bosch processes because maintaining continuous, high temperature, high pressure reaction conditions is expensive. One technique that has been explored is the electrochemical production of ammonia, such as disclosed in, “Ammonia synthesis at atmospheric pressure in a BaCe_{0.2}Zr_{0.7}Y_{0.1}O_{2.9} solid electrolyte cell”; Vasileiou, E. et al.; Solid State Ionics 275 (2015) 110-116. These processes are advantageous in some senses as they can be conducted at lower pressures and temperatures as the electrochemical aspect of the system helps drive the reaction. However, such systems are difficult to scale up as compared to Haber-Bosch processes. Moreover, a significant proportion of the existing infrastructure for producing ammonia is adapted for Haber-Bosch processes.

Given the expensive operating costs, there is demand for improved catalyst materials to allow reactions to proceed at comparable rates under milder conditions and increase the rate of reaction under comparable conditions.

The invention is intended to address or at least ameliorate these issues.

### SUMMARY OF INVENTION

There is provided in a first aspect of the invention, a composition for the catalysis of a Haber-Bosch process, the composition comprising an anion vacant lattice and a Haber-Bosch catalyst.

The term “Haber-Bosch process” is intended to refer to the production of ammonia from a mixture of both hydrogen and nitrogen gases in the presence a heterogeneous catalyst, wherein the hydrogen and nitrogen react together on the surface of the catalyst. In other words, processes akin to those based on the reaction pioneered by Fritz Haber and Carl Bosch. This process is typically conducted at high temperatures and pressure that would be familiar to a person skilled in the art. For instance, the term “Haber-Bosch process” is not considered to encompass the electrochemical synthesis of ammonia as the hydrogen and nitrogen sources are provided in separate chambers and the process is believed to occur via a completely different mechanism, requiring among other things the diffusion of active intermediate species through an electrode.

The term “Haber-Bosch catalyst” is intended to refer to any material that catalyses the production of ammonia in a Haber-Bosch process. Historically, many different materials were used as catalysts (even osmium and uranium were at one time considered as effective catalysts). Subsequent research revealed the effectiveness of other more readily available materials such as cobalt, iron, nickel and ruthenium. It is believed that these materials function well as catalysts for the Haber-Bosch process because they adsorb nitrogen gas and promote the formation of reactive nitrogen species. It is believed that these reactive nitrogen species are what allow the formation of ammonia to happen quickly. Accordingly, a “Haber-Bosch catalyst” as referred to herein is intended to encompass all materials that operate in this capacity.

In order to be suitable as a catalyst in the Haber-Bosch process, the composition must remain sufficiently stable across the range of conditions that the process operates. Typically, the Haber-Bosch process is conducted at temperatures as high as 700° C. and in excess of 20 MPa of pressure.

The term “anion vacant lattice” is intended to describe a material with a structure (e.g. a crystal structure) comprising anions where some of those anions are missing so as to create anion vacancies. This is chiefly achieved using doping. Materials comprising oxygen and nitrogen anions are preferred and hence oxygen and nitrogen vacant lattices are typically employed. The material can be in either crystalline or amorphous state. The terms “oxygen vacant lattice” or “nitrogen vacant lattice” are intended to describe a crystal lattice having oxygen or nitrogen respectively as a key component of the lattice structure and which, either inherently or due to exposure to certain reaction conditions, is missing oxygen or nitrogen ions from its structure so as to leave vacancies within the lattice (having dimensions comparable to an oxygen and nitrogen ion respectively). In some materials, both oxygen and nitrogen vacancies may co-exist such as doped cerium oxynitrides. There is no particular restriction on the type of lattice used in the present invention. The material may also be in an amorphous state. The lattice may be any of the 7 general types of lattice: triclinic, monoclinic, orthorhombic, tetragonal, trigonal, hexagonal, and cubic. Typically, the lattice may be orthorhombic, tetragonal, hexagonal or cubic. Often, the lattice will be cubic or pseudo-cubic. Typical examples of crystal structures used in the invention include perovskites and fluorites. The anion vacant lattice acts as a co-catalyst, augmenting the rate of reaction in combination with Haber-Bosch catalysts.

The inventors have surprisingly found that lattices having anion vacancies function very well as co-catalysts to conventional Haber-Bosch catalysts, leading to significant improvement in catalyst activity compared with conventional catalysts. Without being bound by theory, it is believed that nitrogen gas molecules will dissociatively adsorb on the Haber-Bosch catalyst in the co-catalyst, resulting in an increased tendency of said nitrogen species to react with active hydrogen species on the surface of the “anion vacant lattice” of the co-catalyst composition. The anions within the anion vacant lattices are not particularly limited, but are usually selected from oxygen, nitrogen, fluorine, chlorine, bromine, iodine, sulphur, selenium or combinations thereof. Most typically, the anions in the anion vacant lattices are oxygen and/or nitrogen.

It is typically the case that the composition is configured for catalysis of a Haber-Bosch process. The Haber-Bosch process is a heterogeneous reaction where gases adsorb onto a solid catalyst surface, react and then desorb. Accordingly, the composition is typically formulated for this purpose. This may include providing a minimum surface area of the solid composition so as to ensure efficient reaction rate. For instance, the composition may be provided as: a powder, a coating on a high surface area support; a coating on the supporting particles; impregnated within a porous medium; or a combination thereof.

Whilst there is no particular restriction on the choice of Haber-Bosch catalyst, it is typically the case that the Haber-Bosch catalyst comprises a metal compound selected from the group consisting of: Co, Ni, Fe, Ru, or combinations thereof. More typically, the metal compound is Fe, Ru, or combinations thereof and even more typically, the metal compound is Fe. More typically still, the Haber-Bosch catalyst is an iron oxide (e.g. Fe₂O₃, Fe₃O₄, FeO, Fe₁₋ₓOₓ). Reference to “Co”, “Ni”, “Fe”, “Ru” or other Haber-Bosch catalyst materials is intended to encompass compounds comprising those elements, such as oxides or alloys, as well as their elemental forms. As will be appreciated, the high temperatures and hydrogen concentrations in Haber-Bosch processes means certain catalysts are liable to be reduced and so the material introduced into the system may change in situ.

Typically, the anion vacancies in the anion vacant lattice are created by doping a parent anion lattice (e.g. an oxide or a nitride). Some crystal lattices, when heated or pressurised during a Haber-Bosch process, naturally lose anions (such as oxygen or nitrogen) from their structure, thereby forming vacancies in situ. However, in order to assist this process and/or to create or maximise the number of anion vacancies, dopant ions can be used to create a charge mismatch thereby introducing vacancies into predominantly regular lattices. This is also advantageous not only because it increases the number of vacancies but because (depending on the size of the charge mismatch) it can increase the magnitude of the effect felt by a nitrogen triple bond within the vacancy. The choice of dopant (either relatively electron rich or relatively electron poor) can change the character of the environment surrounding the anion vacancy, in particular the magnitude of the influence upon the nitrogen triple bond. Accordingly, doping allows tailored environments to be created for different scenarios.

A key benefit of this invention is that, any materials with anion vacancies, no matter intrinsic or extrinsic vacancies, can be used as the promoter for Fe, Co and Ru based ammonia synthesis catalysts. The typical anion vacancies are oxygen vacancies and nitrogen vacancies or the combination of both, as existing in some oxynitrides. The catalysts is not limited to only one of Fe, Co, Ni or Ru, it can be the mixture or alloy among these three elements, i.e., Fe, Ru, Ni and/or Co, such as an Fe/Ni alloy.

Whilst there is no particular restriction on the choice of the oxygen vacant lattice to be doped, the oxygen vacant lattice is typically an oxide. Most typically, the oxygen vacant lattice is a fluorite or perovskite structure (but not limited to these structures), such as ceria, zirconia, bismuth oxide, titanium oxide, aluminium oxide, magnesium oxide, iron oxide or combination thereof (all of which may be doped). Of these, ceria, zirconia and titanium oxides are typically the category of materials used most often. Typical examples of suitable oxygen vacant lattice materials include, but are not limited to: BaZrO₃, CaZrO₃, CaAlO₃, CeO₂, MgO, ZrO₂, TiO₂, BaCeO₃, SrZrO₃, LnCeO₃, LnZrO₃, SrCeO₃, Sr_{1.8}Fe₂O₅, Bi₂O₃, SnO₂, LnFeO₃, LnCoO₃, SrCeO₃, SrFe₁₂O₁₉-12Sr₂B₂O₅ or combinations thereof (wherein “Ln” represents lanthanides). SrFe₁₂O₁₉-12Sr₂B₂O₅ is often used and may be in an amorphous form such as an amorphous glass. Typical examples of nitrogen vacant lattices include nitrides or oxynitrides (such as CeO₂₋ₓN_{y}) or doped oxynitrides (such as Ce_{0.5}Sm_{0.5}O₂₋ₓN_{y}). As will be appreciated by the person skilled in the art, the choice of dopant used depends upon the lattice to which it is applied and the character of the environment that is desired. Accordingly, each of the above mentioned materials can be doped to replace one or more of the elements contained therein.

It is often the case that the oxygen vacant lattice, to which a dopant may be added, is selected from: CeO₂, ZrO₂, BaZrO₃, TiO₂, Bi₂O₃, SnO₂ and Sr_{1.8}Fe₂O₅; CeO₂, BaZrO₃, Bi₂O₃, SnO₂ and Sr_{1.8}Fe₂O₅; and more typically CeO₂, BaZrO₃, or combinations thereof. Typically, the oxygen vacant lattice is CeO₂. These materials have been found to be particularly effective starting materials for creating oxygen vacant lattices. This is particularly surprising as they have very different lattice parameters. A parent oxide may be doped with low valent ions, typically +2 and +3 but possibly+1 valence. The parent oxide can be doped with more than one low valent ion, which is known as co-doping.

There may be solid solutions between or among the oxides. For example, CeO₂ and ZrO₂ can form a solid solution, almost in the whole range from x=0 to 1 in,

Ce₁₋ₓZrₓO₂

The oxygen vacancy concentration in the Ce₁₋ₓZrₓO₂ solid solution is quite low as both elements are mainly in +4 valence. However, low valent dopants, such as lanthanides, Ba²⁺, Sr²⁺, Ca²⁺, K⁺, Bi³⁺, Sc³⁺ or other lower valent ions can be doped into the Ce₁₋ₓZrₓO₂ solid solution to form a new solid solution to create oxygen vacancies. For example, according to: W. Huang, P. Shuk, M. Greenblatt, M. Croft, F. Chen, and M. Liu, Structural and Electrical Characterization of a Novel Mixed Conductor: CeO₂—Sm₂O₃—ZrO₂ Solid Solution, Journal of The Electrochemical Society, 147 (11) 4196-4202 (2000).

In the series:

(Ce_{0.83}Sm_{0.17})₁₋ₓZrₓO_{2-δ}

from x=0 to x=0.50, all compositions are in solid solution and the solid solution can be used as a promoter for ammonia synthesis catalyst. For example, a solid solution (Ce_{0.83}Sm_{0.17})_{0.5}Zr_{0.5}O_{2-δ} could be a good promoter.

The same solid solution can be formed among CeO₂, ZrO₂, and TiO₂ at specific composition ranges. Further, doping the CeO₂—ZrO₂—TiO₂ solid solution with lower valent elements with a charge lower than +4, will form oxygen vacancies. These materials can be used as promoters for ammonia synthesis catalysts.

Bi₂O₃ is a very important parent phase as there are intrinsic oxygen vacancies in un-doped Bi₂O₃. When doped with the same or different valent elements such as lanthanides, Y, Pb, Ba, Ce, Sr, W, Mo, Ta, Nb etc., oxygen vacancies will be formed. Since Bi₂O₃ itself has a high concentration of intrinsic oxygen vacancies, doping with elements with a charge of +2, +3, +4, +5, or +6 can achieve a very high concentration of oxygen vacancies. Therefore the formed solid solution can be used as a good promoter for ammonia synthesise catalysts.

A more general formula may be provided as:

A_{1-x-y-z}BₓC_{y}D_{z}Oₘ

wherein at least one of A, B, C, and D, is an element with charge (valency) higher than 3 (+3), for example, Ce, Zr, Ti, Sn, Bi, Si, V, W, Nb, Ta, Hf, or lanthanides which form the solid solution of a phase. For example, Zr_{0.76}Ce_{0.12}Ti_{0.12}O₂ is a single phase solid solution when fired at 1350° C. for 24 hours (Jessica A. Krogstad, Maren Lepple, Carlos G. Levi, Opportunities for improved TBC durability in the CeO₂—TiO₂—ZrO₂ system, Surface & Coatings Technology 221 (2013) 44-52). The inventors propose that partially replacing elements in Zr_{0.76}Ce_{0.12}Ti_{0.12}O₂ with elements having a lower valence (e.g. such as Zr_{0.76}Ce_{0.12}Ti_{0.06}Fe_{0.06}O_{2-δ}) may form a solid solution with oxygen vacancies.

Valence is defined by the IUPAC as: the maximum number of univalent atoms (originally hydrogen or chlorine atoms) that may combine with an atom of the element under consideration, or with a fragment, or for which an atom of this element can be substituted.

At least one of A, B, C, D in A_{1-x-y-z}BₓC_{y}D_{z}Oₘ may have a valence lower than +4, such as lanthanide, Al, Ga, In, Sc, Cr, Mn, Fe, Co, Ni, Cu, Zn, Y, Na, K, Bi, Ba, Sr, Ca, Mg etc. The introduction of a low valent dopant will generate oxygen vacancies thus making the new solid solution a good promoter for ammonia synthesis catalysts.

Typical elements with +4 valence are Ce, Zr and Ti. Typical elements with +3 valence are Al, Sc, Cr, Mn, Fe, Co, Ni, Y, Bi. Typical elements with +2 valence are Ba, Sr, Ca, Mg. Typical elements with +1 valence are Na, K.

In one embodiment A is Ce; and/or B is Zr; and/or C is Ti; and/or D is Ca or Y.

Oxygen Vacancies in Oxyhalides to be Used as Promoter

Besides simple oxides and complicated perovskite oxides, materials with halides in the lattice, such as metal oxyhalides can also be used as promoters for ammonia synthesis catalysts. The typical materials are bismuth oxyhalides such as BiOCl, BiOBr, and BiOI. Other oxyhalides include iron oxyhalides, such as FeOCL, FeOBr, FeOI, and cobalt oxyhalides, such as CoOCL, CoOBr, CoOI. The skilled person will appreciate that the melting point of these oxyhalides must be considered when employing them in the Haber-Bosch process, i.e. the melting points must be higher than the operating temperature for synthesis of ammonia from H₂ and N₂.

Anion Vacancies in Nitrides to be Used as the Catalyst Promoter

Some nitrides, such as Fe₃Mo₃N, Ni₂Mo₃N, Co₃Mo₃N have been reported as good ammonia synthesis catalysts. However, the high cost of these nitrides plus the high activation temperature, normally above 700° C., has limited their practical applications. As these nitrides will lose some lattice nitrogen at high temperatures, we propose to use these nitrides as the promoter to be combined together with Fe, Ru and/or Co based catalyst to increase the activity instead of pure nitride alone. As the general usage of these expensive nitrides is less than 50 wt % of the total Fe-nitride composite catalyst, the overall cost will be significantly reduced.

Beside these known nitrides, any nitrides which contains nitrogen vacancies or can generate nitrogen vacancies under the ammonia synthesis conditions, such as iron nitrides, nickel nitride, cobalt nitride, manganese nitride, vanadium nitride, chromium nitride, titanium nitrides, zirconium nitride, silicon nitrides, aluminium nitride, tin nitride or nitrides with the combination of these elements can be used as the promoter for ammonia synthesis catalysts.

Anion Vacancies in Oxynitrides to be Used as the Catalyst Promoter

The inventors propose that metal oxynitrides such as Ce_{0.5}Sm_{0.5}O₂₋ₓN_{y}, have anion vacancies. It is believed that the anion vacancies are a mixture of oxygen vacancies and nitrogen vacancies. The experimental results demonstrate that oxynitrides such as CeO₂₋ₓN_{y}, CeₐSm_{b}O₂₋ₓN_{y} (e.g. Ce_{0.5}Sm_{0.5}O₂₋ₓN_{y}) and CeₐPr_{b}O₂₋ₓN_{y} (e.g. Ce_{0.5}Pr_{0.5}O₂₋ₓN_{y}) exhibit excellent promotion effects for Fe based ammonia synthesis catalysts. The oxynitrides may be used to promote other catalysts such as Ru, Co etc.

The oxynitrides can be “pure” or doped and include: CeO₂₋ₓN_{y}, TiO₂₋ₓN_{y}, ZrO₂₋ₓN_{y}, Bi₂O₃₋ₓN_{y}, Fe₂O₃₋ₓN_{y}, FeO₄₋ₓN_{y}, Co₂O₃₋ₓN_{y}, CoO₁₋ₓN_{y}, Co₃O₄₋ₓN_{y}, SnO₂₋ₓN_{y}, ZnO₁₋ₓN_{y}, NiO₁₋ₓN_{y}, V₂O₅₋ₓN_{y}, V₂O₃₋ₓN_{y}, MnO₂₋ₓN_{y}, MnO₁₋ₓN_{y}, Mn₃O₄₋ₓN_{y} and combinations thereof.

The oxynitride may be a solid solution, such as Ce₁₋ₐZrₐO₂₋ₓN_{y}.

The oxynitride may be a solid solution that is doped, such as Ti₁₋ₐFeₐO₂₋ₓN_{y} and Ce_{0.4}Zr_{0.4}SM_{0.2}O₂₋ₓN_{y}.

The amount of dopant included within the anion vacant lattice will naturally vary depending upon the number of vacancies required and the ability of the material to retain its general structure. The dopant present within an anion vacant lattice may be a minority component i.e. there is more of the material being replaced than there is dopant replacing it. However, the inventors have determined that the dopant does not need to be a minority component. In fact, higher dopant levels may provide more vacancies, and greater activity. Usually, the dopant is present in an amount in the range 1 mol % to 90 mol %, such as 1 mol % to 70 mol %, such as 1 mol % to 60 mol %, such as 1 mol % to 30 mol % of the total anion vacant lattice, sometimes in an amount in the range 5 mol % to 30 mol % or 30 mol % to 60 mol %, such as 5 mol % to 20 mol % or 40 to 60 mol % of the total anion vacant lattice and often in the range 10 mol % to 40 mol %, such as 10 mol % to 30 mol % of the total anion vacant lattice. The doping level is limited by the solubility limit of the ions in the patent lattice under the preparation conditions. Co-doping of multiple low valent elements may expand the solubility limit and thus maximise the doping level and thus the anion vacancies.

In general, the higher the doping level, the higher the concentration of anion vacancies and the more active sites are available, leading to higher activity. Therefore approaching the doping limit of the solid solution will maximise the anion concentration level in order to achieve the highest activity. However, due to the complexity of the catalytic process, the highest activity may shift away from the highest doping level.

When parent oxides are doped with lower valent ions (e.g. Ce_{0.8}Sm_{0.2}O_{3-δ}, Ce_{0.5}Sm_{0.5}O_{2-δ}, Ce_{0.5}Pr_{0.5}O_{2-δ}, Ce_{0.3}Pr_{0.7}O_{2-δ} and Ce_{0.1}Pr_{0.9}O_{2-δ}), there is a solubility limit. For example, the solubility of SmO_{1.5} (also called Sm₂O₃) in CeO₂ is 50 mol %, which means Ce_{0.5}Sm_{0.5}O_{2-δ} is a single phase. Doping of SmO_{1.5} into CeO₂ up to 50 mol % provides a material having a single phase. Then oxygen vacancies will be generated.

For any doping level beyond the solubility limit of the solid solution, the dopant will not be able to enter the lattice thus oxygen vacancies cannot be generated. Therefore, doping to the solubility limit maximises the doping level. The highest promotion effect may not result from the highest doping level. It can be noted that the solubility limit is not only related to the materials, but also to the firing temperature.

A typical example of an oxygen vacant lattice used in the invention is shown in formula I;

Ba₁₋ₐZrₓCe_{y}Y_{z}O_{3-δ} (formula I)

wherein; “a” represents a value between 0 and 0.2 and each of “x”, “y” and “z” are independently in the range 0.01 to 0.99, typically 0.05 to 0.95, with the proviso that “x”, “y” and “z” together sum to 1. The inventors have found that cerium and yttrium doped barium zirconium oxides (BZCYO) are not only stable at standard Haber-Bosch process operating conditions but also perform very well compared to existing catalysts on the market. Typically, each of “x”, “y” and “z” are independently in the range 0.1 to 0.8 and most typically the oxygen vacant lattice comprises BaZr_{0.1}Ce_{0.7}Y_{0.2}O_{3-δ}, where δ effectively symbolises the number of moles of oxygen vacancy.

In another embodiment of the invention, the oxygen vacant lattice may be a compound according to formula II;

CeₐM_{b}O_{2-δ} (formula II)

wherein, M is an element with a valence lower than 4, typically a lanthanide or rare earth element other than cerium, such as Sm, Pr, Eu, Gd or combinations thereof, or Sm, Eu, Gd or combinations thereof, or Sm, La, Pr, Gd or combinations thereof. “a” and “b” are independently in the range 0.05 to 0.95, with the proviso that “a” and “b” together sum to 1 (approximately). In certain embodiments a is 0.6 or more, 0.7 or more or 0.8 or more and/or 0.7 or less, 0.6 or less or 0.5 or less. Typically, M is Sm. The inventors have found that samarium doped cerium oxide shows good results in promoting the Haber-Bosch process in conjunction with a suitable Haber-Bosch catalyst. Often, each of “a” and “b” are independently in the range 0.1 to 0.8 and it may be the case that the oxygen vacant lattice comprises Ce_{0.8-0.5}Sm_{0.2-0.5}O_{2-δ}, such as Ce_{0.8}Sm_{0.2}O_{2-δ} (SDC), where δ effectively symbolises the number of moles of oxygen vacancy.

The doping level is related to the element. For example, the doping level of PrOₓ in CeO₂ can be 90% PrOₓ, i.e., Ce_{0.1}Pr_{0.9}O_{2-δ}.

All these materials have been found to be stable under standard Haber-Bosch process conditions which is particularly advantageous because, in industry, such process are typically run on a continuous basis. Accordingly, catalyst longevity is important to prevent regular starting and stopping of the process.

In another embodiment of the invention, the anion vacant lattice may be compound according to formula III;

CeₐM_{b}O₂₋ₓN_{y} (formula III)

wherein M is an element with a valence lower than 4, typically a lanthanide or rare earth element other than cerium, such as Sm, Pr, Eu, Gd or combinations thereof; or Sm, Pr, La, Gd or combinations thereof. “a” and “b” are independently in the range 0.05 to 0.95, with the proviso that “a” and “b” together sum to 1 (approximately). 0<X<2 and 0<Y ≤X.

X is greater than 0 and less than 2. Y is greater than zero and less than or equal to X. For example, X may be 0.1 to 1.9. X represents the amount of oxygen “replaced” by nitrogen. Y may be equal to X. Alternatively, Y may be less than X. In one series of embodiments, Y is at least 0.5 X, at least 0.6 X or ⅔ X (0.66X).

Typically, M is Sm or Pr or La, or combinations thereof. In certain embodiments a is 0.3 or more, 0.4 or more, 0.5 or more or 0.6 or more and/or a is 0.9 or less, 0.8 or less, 0.7 or less, 0.6 or less or 0.5 or less.

The examples describe CeₐSm_{b}O₂₋ₓN_{y} where b is 0.1, 0.2, 0.3, 0.4 and 0.5.

The anion vacant lattice may be CeₐPr_{b}O₂₋ₓN_{y} where a is optionally from 0.1 to 0.8, such as 0.3 to 0.5.

The anion vacant lattice may be CeₐLa_{b}O₂₋ₓN_{y} where a is optionally from 0.2 to 0.8, such as 0.3 to 0.7.

In another embodiment of the invention, the anion vacant lattice may be described as a compound according to formula IV;

CeₐM_{b}O₂₋ₓN_{y}□_{z} (formula IV)

wherein M is an element with a valence lower than 4, typically a lanthanide or rare earth element other than cerium, such as Sm, Pr, Eu, Gd or combinations thereof or Sm, Pr, La, Gd or combinations thereof. “a” and “b” are independently in the range 0.05 to 0.95, with the proviso that “a” and “b” together sum to 1. 0<x<2, for example, x may be 0.1 to 1.9. y represents the molar ratio of nitrogen in the lattice. □ represents the un-occupied anion sites, i.e., anion vacancies in the lattice. However, since the valence of nitrogen in the lattice may be different, x and y are normally unequal. For example, if the valence of Ce, O and N in CeO₂₋ₓN_{y} is +4, −2, −3 respectively, for charge balance, y equals to 2x/3. The remaining x/3 at the anion site will be vacant, thus called anion vacancies. Therefore the formula for CeO₂₋ₓN_{y} can be written as CeO₂₋ₓN_{2x/3}□_{x/3} where □ represents anion vacancies. When further doping CeO₂₋ₓN_{2x/3}□_{x/3} with one or more elements with lower valence than +4, for example Ce_{0.5}Sm_{0.5}O₂₋ₓN_{y}□_{z}, then z will include the anion vacancies through the doping of element Sm. If the valence of Ce, Sm, O and N in CeO₂₋ₓN_{y} is +4, +3, −2, −3 respectively, the general formula for Ce_{0.5}Sm_{0.5}O₂₋ₓN_{y}□_{z} can be written as Ce_{0.5}Sm_{0.5}O₂₋ₓN_{2x/3}□_{x/3}. Typically, M is Sm, La or Pr, or combinations thereof. In certain embodiments a is 0.4 or more, 0.5 or more or 0.6 and/or 0.8 or less, 0.6 or less or 0.5 or less. In general we wish to dope to the solubility limit, which varies in different materials or different synthetic conditions.

As explained above, it is believed that the anion vacant lattice activates hydrogen molecules so that they are more prone to react with active nitrogen species on the catalyst surface. However, the Haber-Bosch catalyst is still required to drive the dissociative adsorption of nitrogen portion of the reaction. Accordingly, it is desirable to have a balance of both the Haber-Bosch catalyst and the anion vacant lattice co-catalyst.

In another embodiment of the invention, the composition comprises an anion vacant lattice according to formula V;

ZrₐM_{b}O₂₋ₓN_{y} (formula V)

wherein M is titanium and/or cerium and/or an element with a valence lower than 4, typically a lanthanide or rare earth element, such as Sm, Pr, La, Gd or combinations thereof. “a” and “b” are independently in the range 0.05 to 0.95, with the proviso that “a” and “b” together sum to 1 (approximately). 0<X<2 and 0<Y≤X.

In another embodiment of the invention, the composition comprises an anion vacant lattice according to formula VI;

TiₐM_{b}O₂₋ₓN_{y} (formula VI)

wherein M is zirconium; and/or cerium; and/or an element with a valence lower than 4, typically a lanthanide or rare earth element, such as Sm, Pr, La, Gd or combinations thereof. “a” and “b” are independently in the range 0.05 to 0.95, with the proviso that “a” and “b” together sum to 1 (approximately). 0<X<2 and 0<Y≤X.

It is typically the case that the amount of anion vacant lattice present is in the range 1 wt % to 70 wt % of the total composition. More usually, the amount of anion vacant lattice present in the composition is in the range 2 wt % to 60 wt % of the total composition, and often in the range 3 wt % to 40 wt % of the total composition. More typically, the amount of anion vacant lattice present in the composition is in the range 3 wt % to 30 wt % of the total composition, and usually in the range 3 wt % to 20 wt % of the total composition. Often the amount of anion vacant lattice present is in the range 4 wt % to 6 wt % of the total composition, most typically about 5% of the total composition. The amount of anion vacant lattice present in the composition may be in the range 5 wt % to 30 wt % of the total composition or 10 wt % to 20 wt % of the total composition. The inventors have determined that a composition comprising 20 wt % anion vacant lattice promotes catalysis of the Haber-Bosch process.

It is typically the case that the amount of anion vacant lattice present is in the range 1 mol % to 70 mol % of the total composition. More usually, the amount of anion vacant lattice present in the composition is in the range 2 mol % to 60 mol % of the total composition, and often in the range 3 mol % to 40 mol % of the total composition. More typically, the amount of anion vacant lattice present in the composition is in the range 10 mol % to 35 mol % of the total composition. Often the amount of anion vacant lattice present is in the range 15 mol % to 30 mol % of the total composition, most typically about 25% of the total composition. The amount of anion vacant lattice present in the composition may be in the range 5 mol % to 30 mol % of the total composition or 15 mol % to 25 mol % of the total composition.

There is also provided in a second aspect of the invention, a catalyst cartridge for a Haber-Bosch process, the cartridge comprising the composition according to the first aspect of the invention. In industrial applications of the Haber-Bosch process, the reaction is performed (typically under high pressure) within a reaction vessel. The catalyst is typically suspended within the reaction vessel in a cradle or support structure so as to ensure sufficient exposure of the mixed hydrogen and nitrogen gases to the catalyst. This also permits easy introduction and removal of the catalyst, as compared to simply pouring powder into a reactor. Accordingly, catalyst compositions are often provided in a cartridge format which can simply be inserted into a reactor prior to operation and disposed of once the catalyst has degraded or fallen below a threshold activity. Accordingly, the term “cartridge” as used herein is intended to encompass containers configured to house and permit gaseous interaction with portions of heterogeneous catalyst held therein. The cartridges are typically adapted for easy insertion and removal from a reactor.

The composition is typically provided in the form of a powder or granules due to the large surface area it provides. However, any large surface area arrangement or formulation for heterogeneous catalysis would be suitable (such as those described above), provided the support is stable under typical Haber-Bosch process conditions. Alternatively, the catalyst may be mixed with binders or other materials so as to form particles of a particular size and distribution. The catalyst may also be provided on a support, such as a porous support, typically having a high surface area.

There is also provided, in a third aspect of the invention, a Haber-Bosch process for producing ammonia, comprising the steps of i) providing a composition according to the first aspect of the invention and ii) exposing said composition to a mixture of nitrogen and hydrogen gas.

The conditions of the process can be varied based on the speed of reaction desired and operational requirements of the system. The skilled person would be familiar with the equilibrium process that occurs in a Haber-Bosch reaction and the importance of controlling temperature and pressure to most efficiently favour the formation of ammonia. With the present catalyst, it has been found that less energy intensive conditions are required to provide results comparable to the prior art. Accordingly, the reaction conditions of the process are typically milder than industry standard and often below 600° C. and below 25 MPa or 20 MPa.

The composition may be exposed to a mixture of nitrogen and hydrogen gas at a temperature of 600° C. or less, 500° C. or less, 400° C. or less or 300° C. or less and/or the composition may be exposed to a mixture of nitrogen and hydrogen gas at a temperature of 250° C. or more, 300° C. or more, 350° C. or more, 400° C. or more, or 450° C. or more. It will be appreciated that a temperature gradient may exist across a reactor so reference to a temperature of 600° C. may relate to an average (mean) temperature in the reactor.

The composition may be exposed to a mixture of nitrogen and hydrogen gas at a pressure of 25 MPa or less, 15 MPa or less, 10 MPa or less, 8 MPa or less, 5 MPa or less and/or the composition may be exposed to a mixture of nitrogen and hydrogen gas at a pressure of 1 MPa or more, 3 MPa or more, 5 MPa or more, 8 MPa or more, or 10 MPa or more, or 15 MPa or more, or 20 MPa or more.

The composition may be exposed to a mixture of nitrogen and hydrogen gas at a temperature of 400° C. or less and a pressure of 15 MPa or less.

While the Haber-Bosch process is a continuous-flow technology, the inventors have determined that the present invention is applicable to both continuous and batch processes. The composition of the invention (the combination of the Haber-Bosch catalyst and the anion vacant lattice) allows the use of a lower temperature. In particular, it allows the process to be carried out under conditions which yield a higher proportion of ammonia than usual. As such, it is easier to separate the ammonia from the unreacted hydrogen and nitrogen (if any), thereby making a batch process feasible.

A typical Haber-Bosch process involves a reactor adapted to contain pressurised gas, an area within the reactor to hold the catalyst so as to ensure maximum exposure of the reagent gases thereto, and means for providing and extracting the atmosphere within the reactor. Such reactors are often equipped with external separation means to collect ammonia and return unreacted hydrogen and nitrogen to the reagent source streams. Various systems can be employed to ensure maximum heat retention through this process.

Interestingly, the inventors have found that, when the composition of the invention is used to catalyse the process, intensive purification of the incoming hydrogen and nitrogen gas streams may not be required. It is expected that the activity would be higher when purer reactant gases (mixed H₂ and N₂) are used for ammonia synthesis. Accordingly, one of the advantages that the present composition offers is the ability to perform Haber-Bosch processes without the need for extensive purification of reagents. As such, it is typically the case that the hydrogen and nitrogen used in the process have a purity of more typically greater than 95%, more typically greater than 97%, often greater than 98%, 99%, 99.9%, 99.99% or 99.995%. The impurities are typically traditional components found in air (e.g. water vapour, oxygen, carbon monoxide, carbon dioxide, noble gases, helium and the like) and particulate matter such as small metal particles or dust particles.

It is typically the case that the catalyst is prepared using a solid state reaction, precipitation, co-precipitation, ball-milling, infiltration, sol-gel processes, combustion synthesis or solvent thermal synthesis or any state-of-art methods.

Another option is to mix the oxides or nitrides or oxynitrides with existing industrial catalysts at certain weight ratio to further improve the activity. The oxide promoter or its precursors can be directly added into the precursors for preparation of the existing Fe or Ru based commercial ammonia synthesis catalysts using any methods including the conventional melting method such as those described in W. Arabczyk et al., Studies in Surface and Catalysts, 91, 1995, 677-682.

In a fourth aspect of the invention, there is provided a use of a composition according to the first aspect of the invention for the production of ammonia in a Haber-Bosch process.

In a fifth aspect of the invention, there is provided an anion vacant lattice according to formula III, V or VI, as defined above. The comments above in relation to the anion vacant lattice according to formula III, V or VI apply equally here.

It should be noted that the dopant M is not limited to one element. Co-doping is when the parent phase is doped by more than one element. For example, Ce_{0.5}Sm_{0.3}Pr_{0.2}O₂₋ₓN_{y}.

In particular, the invention resides in an anion vacant lattice according to formula III where M is Sm and a is from 0.1 to 0.9, or from 0.3 to 0.9, or from 0.5 to 0.9, including Ce_{0.9}Sm_{0.1}O₂₋ₓN_{y}, Ce_{0.8}Sm_{0.2}O₂₋ₓN_{y}, Ce_{0.7}Sm_{0.3}O₂₋ₓN_{y}, Ce_{0.6}Sm_{0.4}O₂₋ₓN_{y}, and Ce_{0.5}Sm_{0.5}O₂₋ₓN_{y}.

In particular, the invention resides in an anion vacant lattice according to formula III where M is Pr and a is from 0.1 to 0.9, or from 0.2 to 0.8, including Ce_{0.1}Pr_{0.9}O₂₋ₓN_{y}, Ce_{0.2}Pr_{0.8}O₂₋ₓN_{y}, Ce_{0.3}Pr_{0.7}O₂₋ₓN_{y}, Ce_{0.5}Pr_{0.9}O₂₋ₓN_{y} and Ce_{0.8}Pr_{0.2}O₂₋ₓN_{y}.

In particular, the invention resides in an anion vacant lattice according to formula III where M is La and a is from 0.1 to 0.9, or from 0.2 to 0.8, including Ce_{0.1}La_{0.9}O₂₋ₓN_{y}, Ce_{0.3}La_{0.7}O₂₋ₓN_{y} and Ce_{0.5}La_{0.5}O₂₋ₓN_{y}.

The invention will now be described with reference to the accompanying figures and specific examples.

### BRIEF DESCRIPTION OF FIGURES

FIG. 1 shows XRD images of the BZCY proton conducting support and the supported Ni catalyst before and after stability test.

FIG. 2 shows UV-Vis spectra of the Ni—BZCY catalyst before and after reduction.

FIG. 3 shows SEM images of the unreduced catalyst (a), the reduced catalyst before stability test (b) and the reduced catalyst after stability test (c). The magnification factor was 10000.

FIG. 4 shows a SEM image of the reduced catalyst before stability test with highlighted area of element mapping (a), EDS mapping for Ni (b), EDS mapping for Ba (c), EDS mapping for Zr (d), EDS mapping for Ce (e), EDS mapping for Y (f), EDS mapping for O (g).

FIG. 5 shows (a): STA analysis of dry Ni—BZCY in N₂ (b): STA analysis of wet Ni—BZCY in N₂.

FIG. 6 shows ammonia synthesis rate using a Ni—BZCY catalyst at different temperatures (120 mL min⁻¹, H₂:N₂=3:1).

FIG. 7 shows ammonia synthesis rate using a Ni—BZCY catalyst at different flow rates (620° C., H₂:N₂=3:1).

FIG. 8 shows ammonia outlet concentration at different flow rates (620° C., H₂:N₂=3:1).

FIG. 9 shows ammonia synthesis rate using a Ni—BZCY catalyst at different feed mole ratios (200 mL min⁻¹, 620° C.).

FIG. 10 shows ammonia synthesis rate using 60% NiO/40% MgO—CeO₂ catalyst at different temperatures (120 mL min⁻¹, H₂:N₂=3:1).

FIG. 11 shows ammonia synthesis rate using a Ni—BZCY catalyst over dry and wet stability tests (620° C., 200 mL min⁻¹, H₂:N₂=3:1).

FIG. 12 shows the catalytic activity of pure Fe, Fe with CeO₂ (5 wt %) and Fe with CeO₂ (10 wt %) at a reaction pressure of 10 bar (total flow rate 80 mL min⁻¹, H₂:N₂ mole ratio 3:1).

FIG. 13 shows the catalytic activity of pure Fe, Fe with CeO₂ (5 wt %) and Fe with CeO₂ (10 wt %) at a reaction pressure of 30 bar (total flow rate 80 mL min⁻¹, H₂:N₂ mole ratio 3:1).

FIG. 14 shows the catalytic activity of pure Fe and Fe with SrFe₁₂O₁₉-12Sr₂Br₄O (5 wt %) at reaction pressure of 30 bar (total flow rate 80 mL min⁻¹, H₂:N₂ mole ratio 3:1).

FIG. 15 shows the catalytic activity of Fe catalyst with BCZY (60 wt %) at various pressures (total flow rate 80 mL min⁻¹, H₂:N₂ mole ratio 3:1).

FIG. 16 shows the catalytic activity of Fe₂O₃ with Sr_{1.8}Fe₂O₅ (90 wt % and 85%) at various pressures (total flow rate 80 mL min⁻¹, H₂:N₂ mole ratio 3:1).

FIGS. 17 to 19 show the ammonia synthesis rate for Fe—Ce_{0.8}Sm_{0.2}O_{2-δ} with a support weight percent between 14 and 26% at 3 MPa; Fe—Ce_{0.8}Sm_{0.2}O_{2-δ} with a support weight percent between 14 and 26% at 1 MPa; and Fe-20% CeO₂ and Fe-SDC at 3 MPa, respectively. Catalysts were added such that the total catalyst mass was 300 mg. Reactant gases were supplied at a total volumetric flowrate of 80 mL min⁻¹ with a H₂/N₂ ratio of 3. The outlet gases were passed through a 0.01M sulphuric acid trap and the produced ammonia was measured using an ISE Thermo Scientific Orion Star A214 ammonia meter.

FIG. 20 shows the activity of the 80% Fe-20% Ce_{0.8}Sm_{0.2}O_{2-δ} catalyst over 200 hours on stream. Both temperature and pressure were kept constant at 450° C. and 3 MPa respectively. Feed gas was kept and a constant mole ratio of 3 to 1 H₂ to N₂ respectively. A gas flowrate of 80 mL min⁻¹ was employed during the tests but was reduced to 40 mL min⁻¹ overnight.

FIG. 21 shows the proposed reaction pathway on the catalyst in which nitrogen is dissociatively adsorbed on the Fe surface and undergoes hydrogenation. Hydrogen gas is ionised on the Ce_{0.8}Sm_{0.2}O_{2-δ} surface. The reaction intermediate NH* is then reacting with OH₀ on the Ce_{0.8}Sm_{0.2}O_{2-δ} surface at the contact points between Fe and Ce_{0.8}Sm_{0.2}O_{2-δ} to undergo the final stages of hydrogenation producing adsorbed ammonia on the Ce_{0.8}Sm_{0.2}O_{2-δ} surface.

FIG. 22 shows ammonia synthesis rate for the best performing Fe-20% Ce_{0.5}Sm_{0.5}O₂₋ₓN_{y} catalyst composition compared to the Fe-20% CeO₂₋ₓN_{y} catalyst, Fe-20% CeO₂₋ₓN_{y} calcined catalyst, Fe-20% CeO₂ catalyst, and industrial magnetite Fe catalyst. All measurements were at 400° C. at either 3 MPa (left) or 1 MPa (right).

FIG. 23 shows the ammonia synthesis rate for Fe—CeO₂, Fe—CeO₂₋ₓN_{y}, Fe—Ce_{0.5}Sm_{0.5}O₂₋ₓN_{y} with a support weight percent of 20% at 3 MPa. Ce_{0.5}Sm_{0.5}O₂₋ₓN_{y} has the highest activity (uppermost line) with a peak activity at 400° C. For comparison Ce_{0.8}Sm_{0.2}O₂₋ₓN_{y} has a peak at 500° C. (see FIG. 26).

FIG. 24 shows the ammonia synthesis rate for Fe—CeO₂, Fe—CeO₂₋ₓN_{y}, Fe—Ce_{0.5}Sm_{0.5}O₂₋ₓN_{y} with a support weight percent of 20% at 1 MPa. Ce_{0.5}Sm_{0.5}O₂₋ₓN_{y} has the highest activity (uppermost line) with a peak activity at 450° C.

FIG. 25 shows the activity of Fe—CeO₂₋ₓN_{y} catalyst over 200 hours on stream. Both temperature and pressure were kept constant at 450° C. and 3 MPa respectively. Feed gas was kept and a constant mole ratio of 3 to 1 H₂ to N₂ respectively. A gas flowrate of 80 mL min⁻¹ was employed.

FIG. 26 shows the activity of Fe-20% CeₐSm_{b}O₂₋ₓN_{y} catalysts at various temperatures at 3 MPa.

FIG. 27 shows the activity of Fe-20% CeₐSm_{b}O₂₋ₓN_{y} catalysts at various temperatures at 1 MPa.

FIG. 28 shows the activity of Fe—Ce_{0.5}Sm_{0.5}O₂₋ₓN_{y} catalyst at over 200 hours on stream. Both temperature and pressure were kept constant at 400° C. and 3 MPa respectively. Feed gas was kept and a constant mole ratio of 3 to 1 H₂ to N₂ respectively. A gas flowrate of 80 mL min⁻¹ was employed.

FIG. 29 shows the activity of 10% Ru—Ce_{0.5}Sm_{0.5}O₂₋ₓN_{y} at 3 MPa and 1 MPa under different temperatures.

FIG. 30 shows the Raman spectra of pure CeO₂, CeO₂₋ₓN_{y} and Ce_{1-z}Sm_{z}O₂₋ₓN_{y} indicating the presence of oxygen vacancies in the doped cerium oxynitrides.

FIG. 31 shows the catalytic activity of 80% Fe-20% ZrO₂ (99+% excluding HfO₂ (2%), Alfa Aesar) and 80% Fe-20% YSZ (yttrium stabilized zirconia, PI-KEM Ltd) at 3 MPa. Reactant gases were supplied at a total volumetric flowrate of 80 mL min⁻¹ with a H₂/N₂ molar ratio of 3.

FIG. 32 shows room temperature XRD patterns of Ce_{1-z}Sm_{z}O₂₋ₓN_{y} with z=0 to 0.5, demonstrating a single phase.

FIG. 33 shows the lattice parameter of the pure and Sm-doped cerium oxynitrides.

FIG. 34 shows room temperature XRD patterns of Ce_{1-z}Pr_{z}O₂₋ₓN_{y} with z=0.8 and 0.9, demonstrating a single phase.

### EXAMPLES

### Example 1

Synthesis of BZCY

In order to synthesise the BaZr_{0.1}Ce_{0.7}Y_{0.2}O_{3-δ} (BZCY) perovskite catalyst support a solid state reaction was employed. Firstly stoichiometric amounts of BaCO₃ (99% alfa), ZrO₂ (99% alfa), CeO₂ (99.5% Alfa) and Y₂O₃ (99.9% Alfa) were weighed and mixed using a pestle and mortar. The resulting mixture was then wet ground in isopropyl alcohol for 12 hours. After drying at 80° C. the mixture was then fired at 1000° C. for 3 hours with a heating and cooling rate of 5° C. min⁻¹. After this NiO (99% Alfa) was added to the BaZr_{0.1}Ce_{0.7}Y_{0.2}O₃ powder with a weight ratio of 60% to 40% respectively. This was further wet ground in isopropyl alcohol for 12 hours. The MgO—CeO₂ support for the comparison test was prepared through a combustion synthesis in which equimolar amounts of Ce(NO₃)₃·6H₂O (99.5% alfa) and Mg(NO₃)₂·6H₂O (98% alfa) were dissolved in deionised water, citric acid (99% alfa) was then added with the mole ratio of 1:1 against total moles of metal ions. This solution was then heated on a hot plate at 200° C. until the combustion was complete with the resulting powder fired at 500° C. for 2 hours.

Materials Characterisation

The catalyst was characterised using both X-ray Diffraction (XRD) and Scanning electron microscopy (SEM). The crystal structures were determined using a Panalytical X'Pert Pro Multi-Purpose Diffractometer (MPD) with Cu K alpha 1 radiation working at 45 kV and 40 mA. The SEM images were obtained with ZEISS SUPRA 55-VP operating at 10 kV. Thermal gravimetry-differential scanning calorimetry (TG-DSC) analyses of pre-reduced Ni—BZCY catalysts were carried out on a NETSCH F3 thermal analyser in flowing N2 to 800° C. with an N₂ flowing rate of 70 ml min⁻¹. The UV-Vis measurements were carried on a Shimadzu 3600 Spectrophotometer with integrating sphere for solid samples. The samples were mixed with BaSO₄ to fill in the sample holder before the measurements. The specific surface area of both the Ni—BZCY catalyst and the Ni—MgO—CeO₂ catalyst was measured using a QUADRASORB SI surface area analyser. Both of the reduced samples were degassed at 350° C. before carrying out surface area analysis at liquid nitrogen temperature.

Catalyst Activity Measurement

To measure the catalytic activity 0.48 g of catalyst was loaded into an alumina reactor and was supported in the centre on glass fibre. The catalyst was then reduced at 700° C. in H₂ and N₂ with a total flow rate of 100 mL min⁻¹ and mole ratio of 9:1 H₂:N₂ for 4 hours. After this the temperature, total flow rate and flow rate ratio were adjusted in order to determine the optimal conditions. H₂ and N₂ from gas cylinders were directly used without any purification process. For the stability test, the catalyst was cooling down to room temperature under the protection of mixed H₂/N₂ (3:1 m/o), then N₂ passing through room temperature water was passed through the catalyst for one hour. After this process, the gas was switched to mixed H₂ and N₂ then slowly heated to 620° C. to continue the ammonia synthesis measurement.

Dilute H₂SO₄ (0.01 M) was used to collect any produced ammonia which was then measured using ISE Thermo Scientific Orion Star A214 ammonia meter. Both hydrogen and nitrogen were used from the cylinder with no further purification.

In order to calculate the ammonia synthesis rate the following equation was used:

$${r}_{N {H}_{3}} = \frac{[ N {H}_{4}^{+} ] \times V}{t \times m} \qquad ( 9 )$$

where [NH₄⁺] is ammonia concentration in mol L⁻¹, V is volume of 0.01M H₂SO₄ in L, t is time in hours and m is catalyst mass in grams.

XRD Analyses

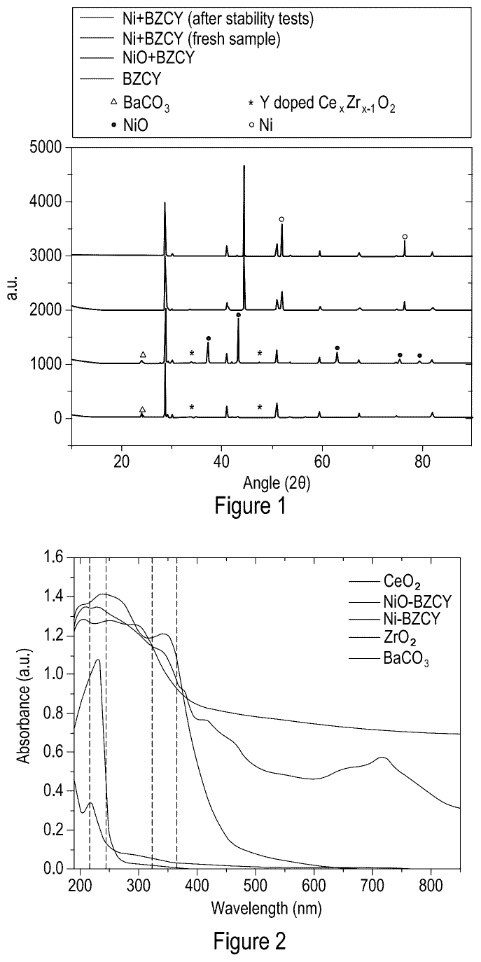

In the XRD results shown in FIG. 1 it can be seen that there are some small peaks attributed to BaCO₃ and Y-doped CeₓZr₁₋ₓO₂ present for BaZr_{0.1}Ce_{0.7}Y_{0.2}O_{3-δ} before and after being mixed with the NiO, however, after reduction at 700° C. in H₂/N₂ mixture (90% Hz) for 4 hours, these peaks are no longer present. A possible reason is that, BaCO₃ and Y-doped CeₓZr₁₋ₓO₂ were converted into amorphous phase during the reduction process thus cannot be detected by XRD. The XRD peaks for the catalyst before and after the stability test are the same although the intensity of the Ni peak has increased after the stability tested showing the possible aggregation of Ni particles whilst better crystallisation is another possible reason

UV-Visible Observation

In order to identify the BaCO₃ phase, the absorbance spectra of the catalyst were measured before and after reduction to investigate whether or not BaCO₃ and Y-doped CeₓZr₁₋ₓO₂ are converted into amorphous phases. The absorbance spectra of pure BaCO₃, ZrO₂, CeO₂ and the catalysts before and after catalysts test were measured using a Shimadzu UV-2600 with integrating sphere. The results are shown in FIG. 2. It was observed that after reduction none of BaCO₃, zirconia or ceria can be identified in the reduced catalyst. Therefore, it was shown that an amorphous phase was not formed by BaCO₃, zirconia or ceria and they are not present in the reduced catalyst. One possible reason is that, the tiny amounts of BaCO₃ second phase was covered by a thin layer of Ni when NiO was reduced by Hz whilst diffusion of newly formed Ni is very likely, thus BaCO₃ cannot be detected by either XRD or UV-Vis spectrometer.

SEM Observation

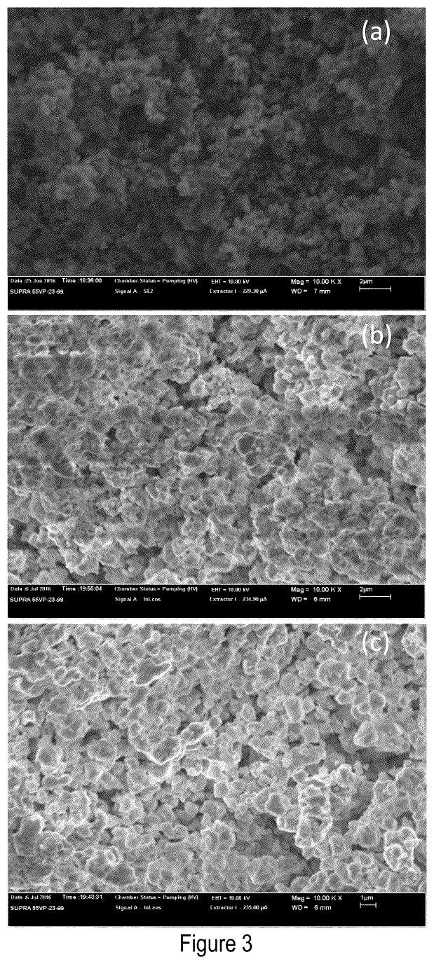

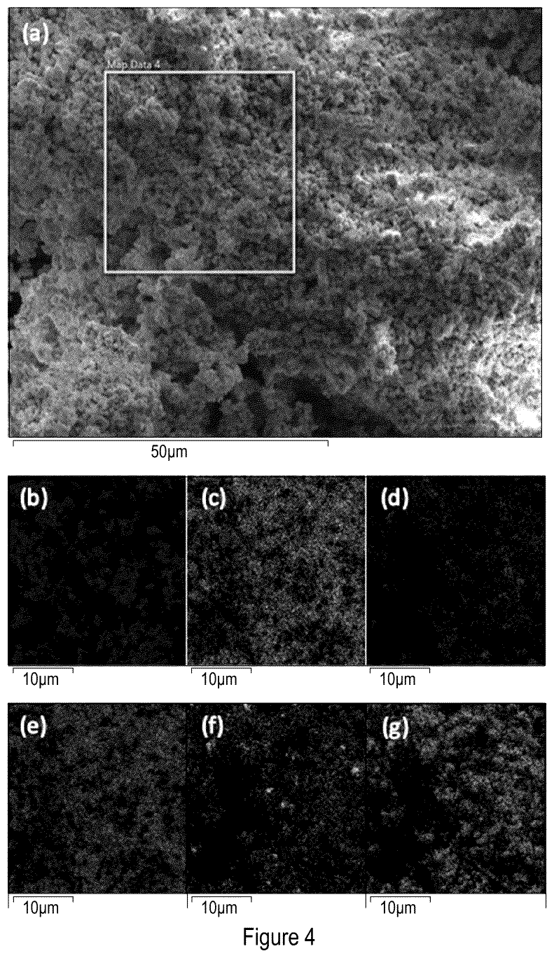

FIG. 3a&b show the SEM pictures of unreduced NiO—BZCY catalyst. The big particles are BCZY oxide with small NiO particles homogeneously distributed in the oxide matrix. After the reduction (FIG. 3c&d), the particle size slightly became larger. Element mapping of reduced Ni—BZCY is shown in FIG. 4. The distribution of Ni (FIG. 4b) is homogeneous.

TG-DSC Analysis

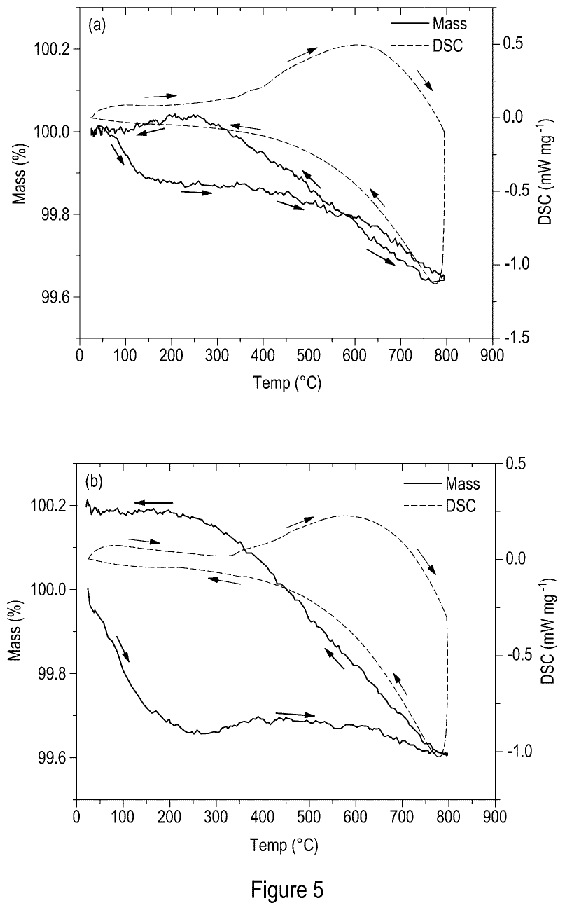

In order to figure out the effects of moisture on the properties of the reduced Ni—BZCY catalyst, TG-DSC analyses were carried out for both dry and wet reduced Ni—BZCY catalysts. For the wet catalyst, reduced Ni—BZCY catalyst was exposed to flowing air through room temperature for 1 hour before the TG-DSC measurement. The TG-DSC data for both samples are shown below in FIGS. 5(a) and (b) respectively. For the dry catalyst, the initial weight loss below 100° C. (˜0.12 wt %) is due to the loss of absorbed water. Slight weight gain on cooling peaked at ˜270° C. (˜0.03 wt %) was observed, possibly due to the adsorption of steam by BZCY. When the wet reduced Ni—BZCY was used, the initial weight loss continued at a much higher temperature, until ˜250° C. with larger weight loss (˜0.34 wt %) indicating BZCY can hold water to a higher temperature. A shoulder weight gain peaked around 450° C. was observed which is due to water uptake, which was also observed in protonic conducting oxides. On cooling, more water uptake (˜0.18 wt %) was observed indicating BZCY can strongly uptake water at lower temperature.

Effect of Temperature on Catalyst Activity

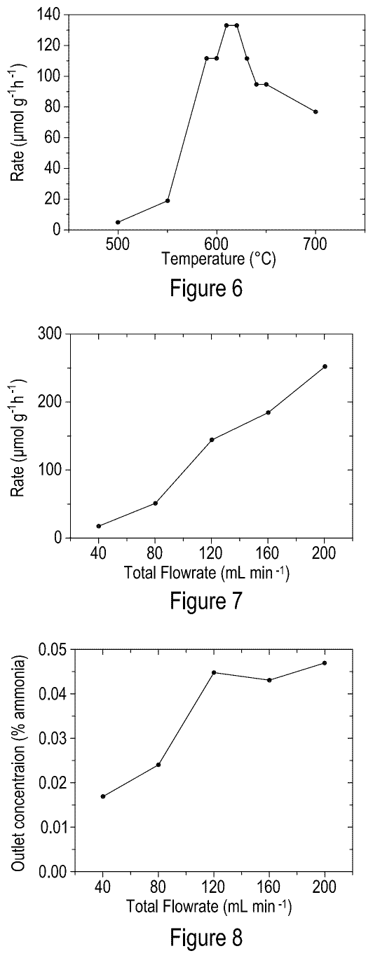

When a constant flow rate was kept at 120 mL min⁻¹ and H₂:N₂ were flown with a mole ratio of 3:1 the effects of changing temperature could be observed, this is shown in FIG. 6. It was observed that the activity increases up to a maximum of approximately 135 μmol g⁻¹h⁻¹ at 620° C. before dropping again. At lower temperature, the catalytic activity of the Ni—BZCY catalyst is not high enough. At a higher temperature, the produced ammonia may decompose, leading to lower production rate. In FIG. 5b, a weight loss at ˜650° C. was observed due to the loss of updated water. This temperature is very close to the highest catalytic activity as shown in FIG. 6. Therefore promotion effect of the BZCY could be related to the updated water at high temperature.

Effect of Total Flow Rate on Catalyst Activity

The effect of total flow rate was then tested at a constant temperature of 620° C. with the results shown in FIG. 7. It can be seen that the activity increases with increasing flow rate. This increase in activity expected to be due solely to the increase in reactant gas, in order to confirm this ammonia outlet concentration was plotted against total gas flow rate.

As shown in FIG. 8, when total flow rate is plotted against ammonia outlet concentration, it rises up to a total flow rate of 120 mL min⁻¹ before levelling off. This therefore shows that the total flow rate is independent of conversion rate over a value of 120 mL min⁻¹ in our experiments and that the activity measured at this these flow rates is solely due to catalytic activity. However, at total gas flow rates less than 120 ml min⁻¹, lower outlet ammonia concentration was observed. The possible reason is that, majority of the mixed gas passed through the edge of the glass fibre where the loading of catalyst was relatively lower thus the contact time with the catalyst was short leading to reduced ammonia formation.

Effect of Feed Gas Ratio on Catalyst Activity

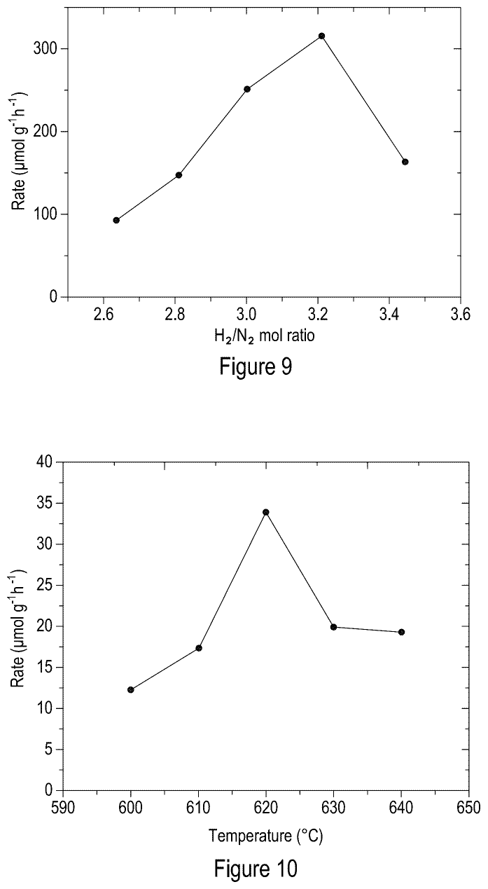

To determine the optimal feed ratio the gas inlet mole ratio was adjusted between 2.6 and 3.4 (H₂/N₂) with the optimal being detected for a value of 3.2 with a rate of approximately 320 μmol g⁻¹h⁻¹ (FIG. 9). All measurements were taken at 620° C. with a total flow rate of 200 ml/min. The reason for this deviation from the normal may be due to the proton conducting nature of the BZCY support with some of the fed H₂ being ionised and transferred to the support as H⁺ therefore adjusting the value of H₂ to N₂ in the reactor closer to the stoichiometric value of 3.

Effect of Temperature on Catalyst Activity of 60% NiO/40% MgO—CeO₂

In order to examine the promotion effects of the proton conducting nature of the catalyst support, a Ni catalyst supported on a non-proton conductor was tested under the same conditions. MgO—CeO₂ composite is an excellent support for Ru catalysts for ammonia synthesis. In this study, for comparison, Ni supported in MgO—CeO₂ composite was also synthesised and the catalytic activity was also investigated. This was tested over the temperature range of 600° C. to 640° C. with a hydrogen to nitrogen mole ratio of 3 and a total flow rate of 120 mL min⁻¹ (FIG. 10). From this it can be seen that the maximum flow rate achieved was at 620° C. mirroring that results obtained for the BZCY support. However, the activity of this catalyst is around 4 times lower than the activity of the Ni catalyst when used with the BZCY proton conducting support (FIG. 6). However, the catalytic activity is related to the specific surface area. The specific surface area was measured to be 0.907 m² g⁻¹ for the Ni—BZCY catalyst and 16.940 m² g⁻¹ for the Ni—MgO—CeO₂ catalyst. The specific surface area of Ni—BZCY is only 5.3% of that of Ni—MgO—CeO₂ but the catalytic activity to ammonia synthesis is much higher. This experiment further demonstrates that proton-conducting oxide BZCY has obvious promotion effects on ammonia synthesis.

Stability of Catalytic Activity in the Presence of Moisture

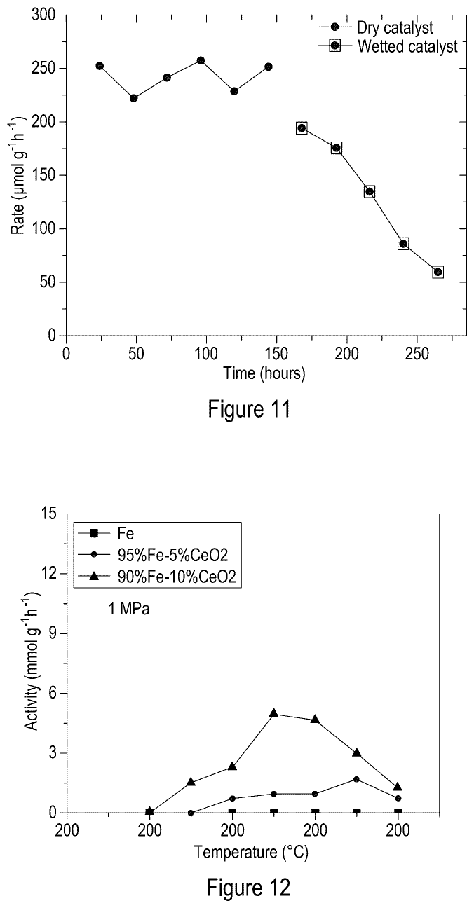

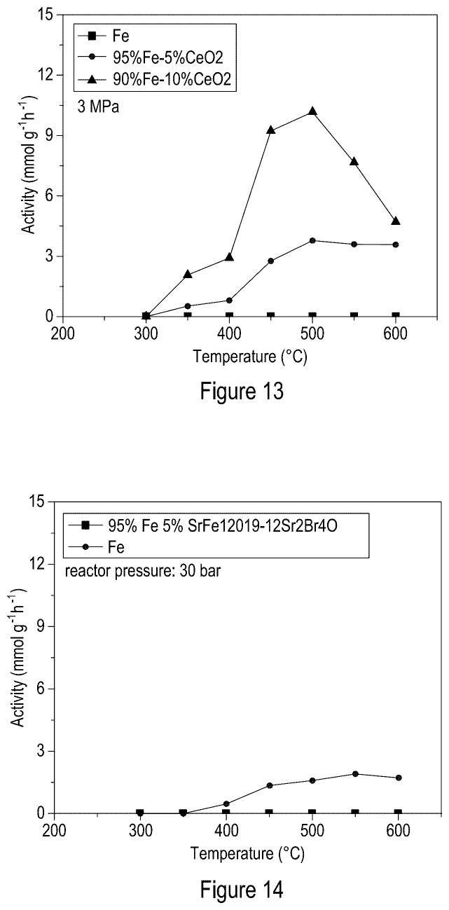

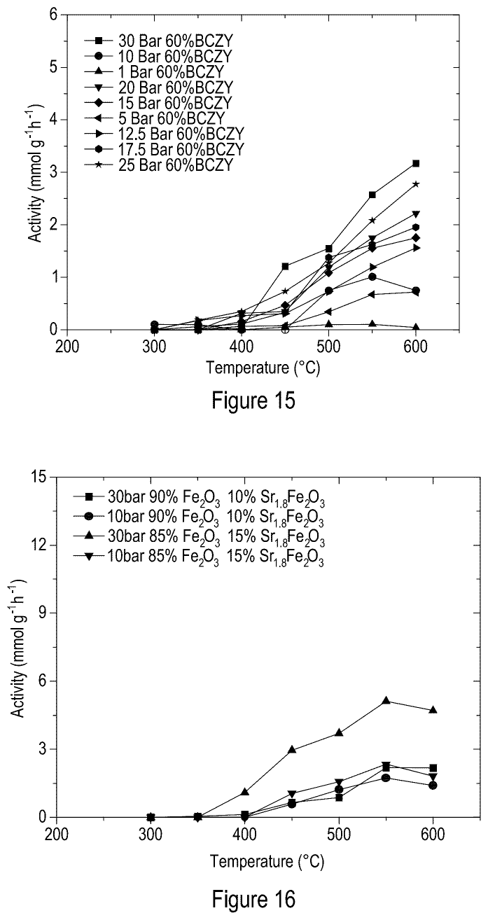

The stability of ammonia synthesis catalysts in the presence of an oxidant is a big challenge. The catalyst stability was investigated over 144 hours at 620° C. with a H₂/N₂ mole ratio of 3 and a total flow rate of 200 mL min⁻¹. The catalyst was found to be stable over this period with no loss of activity as can be seen in FIG. 11. After this the effect of wetting the catalyst was also investigated. To perform these experiments the reactor was cooled to room temperature and wet nitrogen (100 mL min⁻¹) was bubbled through the reactor for 1 hour before being heated back to 620° C. at a rate of 1° C. min⁻¹. This was repeated 5 times with the results shown in FIG. 11. It can be seen from the results that there is a drop in activity after each cycle with an overall linear drop over the 5 cycles. The activity drops to approximately a fifth of its original value after 5 cycles going from approximately 250 μmol g⁻¹h⁻¹ to 50 μmol g⁻¹h⁻¹ with a further drop expected on further wetting cycles. This loss of activity was suspected to be caused either due to the poisoning effect of the water on the Ni catalyst after being wetted at room temperature because slight oxidation of Ni on the surface may happen as the case for Fe-based catalysts. However, upon examining the XRD patterns and SEM images of the reduced catalyst after the stability test no major changes were observed from the freshly reduced catalyst (FIGS. 1&3). However, a trace amount of NiO may still have been formed after treating the catalyst but is beyond the measurement limit for XRD. The oxidation and reduction cycles that the Ni catalyst undergoes in the wetted catalyst may also damage the active sites on the catalyst greatly speeding up the degradation of the catalyst that would be noticed over the catalysts life time. Evidence for this was observed during the XRD which showed an increase in intensity of the Ni peak after the stability test suggesting possible better crystallisation of Ni particle leading to loss of active sites on the Ni surface. This effect of enhanced catalyst degradation may also be attributed to the heating and cooling cycles in-between each data point on the wetted catalyst stability test.

As well as the BZCY promoted catalyst pure Ni was also tested with a rate of 25.12 μmol g⁻¹h⁻¹ observed at 620° C. with a total flow rate of 200 mL/min and a H₂/N₂ ratio of 3. This is roughly ten times lower than that for the BZCY promoted catalyst when the same weight of nickel oxide was used. This therefore shows the excellent promotion effects that can be achieved using the BZCY proton conducting support.

When investigating materials as potential supports for ammonia synthesis catalysts the electro negativity of the support is a strong consideration. In this work, we have shown that another desirable effect of a support material may be its ability to conduct protons. This promoting ability of proton conducting supports can be explained by the ionisation of the H₂ gas fed to the reactor. By using a proton conducting support it is proposed that the dissociated hydrogen on the active sites is then transferred in to the support freeing the site for the adsorption of nitrogen.

### Example 2

Catalyst Preparation Method
i) Preparation of Fe—SrFe₁₂O₁₉-12Sr₂B₂O₅ Catalyst

18.4538 g SrCO₃, 7.4196 g H₃BO₃, 4.7907 g Fe₂O₃ were mixed in agate mortar and pestle, then put in an alumina crucible, pre-fired at 700° C. for 24 hours. The pre-fired powder was ground and mixed in an agate mortar then put back in the same alumina crucible and fired at 1250° C. for 2 hours. The melt in the alumina crucible was quenched to a steel plate at room temperature to obtain a glass material. The obtained Fe—SrFe₁₂O₁₉-12Sr₂B₂O₅ amorphous powder, was mixed with commercial Fe₂O₃ (Alfa) with a weight ratio of 9.5/0.5 for Fe₂O₃:Fe—SrFe₁₂O₁₉-12Sr₂B₂O₅ to be used for ammonia synthesis. The loading of the composite catalysts was 300 mg after reduction to Fe:Fe—SrFe₁₂O₁₉-12Sr₂B₂O₅. The H₂ and N₂ flow rates were 60 ml min⁻¹ and 20 ml min⁻¹ respectively at ambient temperature and pressure. The synthesised ammonia was collected by 100 ml (0.01M) H₂SO₄ solution and was measured by a Fisher Scientific Orion A214 ammonia meter.
ii) Preparation of Fe—BaZr_{0.1}Ce_{0.7}Y_{0.2}O_{3-δ}

Stoichiometric amounts of BaCO₃ (99% alfa), ZrO₂ (99% alfa), CeO₂ (99.5% Alfa) and Y₂O₃ (99.9% Alfa) were weighed and mixed using a pestle and mortar. The resulting mixture was then wet ground in isopropyl alcohol for 12 hours. After drying at 80° C. the mixture was then fired at 1000° C. for 3 hours with a heating and cooling rate of 5° C. min⁻¹. The obtained BaZr_{0.1}Ce_{0.7}Y_{0.2}O_{3-δ} powder was mixed with commercial Fe₂O₃ (Alfa) with weight ratio of 4/6 for Fe₂O₃:BaZr_{0.1}Ce_{0.7}Y_{0.2}O_{3-δ} to be used for ammonia synthesis. The loading of the composite catalysts was 300 mg after reduction to Fe:BaZr_{0.1}Ce_{0.7}Y_{0.2}O_{3-δ}. The H₂ and N₂ flow rates were 60 ml min⁻¹ and 20 ml min⁻¹ respectively at ambient temperature and pressure. The synthesised ammonia was collected by 100 ml (0.01M) H₂SO₄ solution and was measured by a Fisher Scientific Orion A214 ammonia meter.
iii) Preparation of Fe—Ce_{0.8}Sm_{0.2}O_{2-δ} (SDC)

0.001 mol 0.3487 g Sm₂O₃ was dissolved in dilute nitric acid at a temperature around 60° C. until Sm₂O₃ powder was completely dissolved to form an aqueous samarium nitrate solution. 0.008 mol, 3.4738 g Ce(NO₃)₃·6H₂O was added into the as-prepared samarium nitrate solution to form a mixed nitrate solution. The concentration in terms of total metal ions is around 0.05M. Dilute ammonia solution was slowly added into the cerium nitrate solution with stirring until the pH value reached 10. The reaction was allowed to continue at room temperature for 1 hour. The obtained precipitate was filtered and washed with deionised water several times. After drying at room temperature inside a fume cupboard, the dried precipitate was transferred into an alumina crucible and fired at 600° C. for 2 hours with a heating/cooling rate of 5° C. min⁻¹. The obtained Ce_{0.8}Sm_{0.2}O_{2-δ} powder was mixed with commercial Fe₂O₃ (Alfa) with weight ratio of 9.5/0.5 for Fe₂O₃:Ce_{0.8}Sm_{0.2}O_{2-δ} to be used for ammonia synthesis. The loading of the composite catalysts was 300 mg after reduction to Fe:Ce_{0.8}Sm_{0.2}O_{2-δ}. The H₂ and N₂ flow rates were 60 ml min⁻¹ and 20 ml min⁻¹ respectively at ambient temperature and pressure. The synthesised ammonia was collected by 100 ml (0.01M) H₂SO₄ solution and was measured by a Fisher Scientific Orion A214 ammonia meter.
iv) Preparation of Fe—CeO₂

Dissolve 0.01 mol, 4.3423 g Ce(NO₃)₃·6H₂O in deionised water to obtain 0.05M aqueous solution. Dilute ammonia solution was slowly added into the cerium nitrate solution with stirring until the pH value reaches 10. Allow the reaction to continue at room temperature for 1 hour. The obtained precipitate was filtered and washed by water to remove the remaining ions. After drying at room temperature inside a fume cupboard, the dried precipitate was transferred into an alumina crucible and fired at 600° C. for 2 hours with a heating/cooling rate of 5° C. min⁻¹. The obtained CeO₂ powder was mixed with commercial Fe₂O₃ (Alfa) with weight ratio of 9:1 and 9.5/0.5 for Fe₂O₃:CeO₂ to be used for ammonia synthesis. The loading of the composite catalysts was 300 mg after reduction to Fe:CeO₂. The H₂ and N₂ flow rates were 60 ml min⁻¹ and 20 ml min⁻¹ respectively at ambient temperature and pressure. The synthesised ammonia was collected by 100 ml (0.01M) H₂SO₄ solution and was measured by a Fisher Scientific Orion A214 ammonia meter.
v) Preparation of Fe—Sr_{1.8}Fe₂O₅

Sr(NO₃)₂ and Fe(NO₃)₃·9H₂O were dissolved in deionised water with a mol ratio of 1.8 to 2 respectively. Citric acid and EDTA were then added with mol ratio of 1:1:1 to metal ions. This mixture was continuously stirred for 1 hour at 30° C. before increasing to 200° C. The resulting gel like product was then combusted at 200° C. to obtain the powder product. This was calcined at 700° C. for 12 hours with a heating and cooling rate of 5° C. min⁻¹. The resulting Sr_{1.8}Fe₂O₅ powder was then reduced in H₂/N₂ (total flowrate 50 ml min⁻¹, mol ratio 3:1) at 800° C. for 12 hours with a heating and cooling rate of 5° C. min⁻¹ to exsolve the excess Fe on to the surface as nanoparticles. The obtained Sr_{1.8}Fe₂O₅ powder was mixed with commercial Fe₂O₃ (Alfa) with weight ratio of 9/1 and 8.5/1.5 for Fe₂O₃:Sr_{1.8}Fe₂O₅ to be used for ammonia synthesis. The loading of the composite catalysts was 300 mg after reduction to Fe:Sr_{1.8}Fe₂O₅ The H₂ and N₂ flow rates were 60 ml min⁻¹ and 20 ml min⁻¹ respectively at ambient temperature and pressure. The synthesised ammonia was collected by 100 ml (0.01M) H²SO⁴ solution and was measured by a Fisher Scientific Orion A214 ammonia meter.

Fe—Ce_{0.8}Sm_{0.2}O_{2-δ} (SDC) Investigation

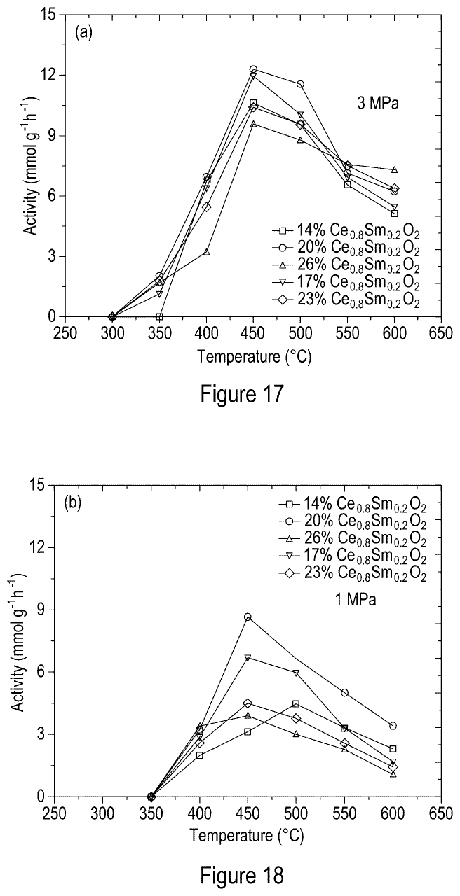

The activities of Fe-SDC on ammonia synthesis at high temperature at 3 MPa and 1 MPa are shown in FIGS. 17 and 18 respectively. Generally the catalyst with 20 wt % SDC exhibits the highest activity of the different SDC promoter ratios tested. At this ratio, the rates for N₂ cleavage on Fe and H₂ dissociation on SDC match well to maximize the production of ammonia. For both measured pressures, the highest ammonia production rate was observed at 450° C.

Table 1 provides a comparison of selected highly active ammonia synthesis catalysts. Activity was measured at optimal pressure and temperature. The purity of the gas supply used was also compared.

| | | | | Activity | |
|---|---|---|---|---|---|
| | H₂/N₂ | Synthesis | | (mmol | |
| Catalyst | gas Purity | conditions | | g⁻¹ h⁻¹) | reference |
| Co₃Mo₃N | 99.9999% | T = | 400° C. | 5.36 | (1) |
| | with further | P = | 10 MPa | | |
| | purification | | | | |
| 10% | 99.99995% | T = | 360° C. | 60.4 | (2) |
| Ru/Ba—Ca(NH₂)₂ | | P = | 0.9 MPa | | |
| 1.2% Ru/C12A7:e⁻ | 99.99995% | T = | 400° C. | 8.245 | (3) |
| | | P = | 1.0 MPa | | |
| 8.3% Ru/LaScSi | 99.99995% | T = | 400° C. | 19 | (4) |
| | | P = | 1.0 MPa | | |
| 5% Ru/Pr₂O₃ | Unreported | T = | 400° C. | 19 | (5) |
| | | P = | 1.0 MPa | | |
| Fe—LiH | Unreported | T = | 350° C. | 12 | (6) |
| | | P = | 1 MPa | | |
| Wüstite based | 99.99995% | T = | 450° C. | 16 | (2) |
| industrial | | P = | 0.9 MPa | | |
| Fe catalyst | | | | | |
| Magnetite based | 99.995% | T = | 450° C. | 1.7 | This work |
| industrial Fe | | P = | 1 MPa | | |
| catalyst | | | | | |
| 80% Fe— | 99.995% | T = | 450° C. | 8.7 | This work |
| 20% Ce_{0.8}Sm_{0.2}O_{2-δ} | | P = | 1 MPa | | |

(1) C. J. H. Jacobsen, Chemical Communications, 1057-1058 (2000).
(2) M. Kitano, Y. Inoue, M. Sasase, K. Kishida, Y. Kobayashi, K. Nishiyama, T. Tada, S. Kawamura, T. Yokoyama, M. Hara, H. Hosono, Angewandte Chemie International Edition 57, 2648-2652 (2018).
(3) M. Kitano, Y. Inoue, Y. Yamazaki, F. Hayashi, S. Kanbara, S. Matsuishi, T. Yokoyama, S .-W. Kim, M. Hara, H. Hosono, Nature Chemistry 4, 934-940 (2012).
(4) J. Z. Wu, Y. T. Gong, T. Inoshita, D. C. Fredrickson, J. J. Wang, Y. F. Lu, M. Kitano, H. Hosono, Adv. Mater, 29, (2017).
(5) K. Sato, K. Imamura, Y. Kawano, S. Miyahara, T. Yamamoto, S. Matsumura, K. Nagaoka, Chemical Science 8, 674-679 (2017).
(6) P. Wang, F. Chang, W. Gao, J. Guo, G. Wu, T. He, P. Chen, Nature Chemistry 9, 64-70 (2016).

At 1 MPa and 450° C., the activity of Fe catalyst promoted with 20 wt % SDC is 8.7 mmolg⁻¹h⁻¹, which is lower than the Wustite based industrial Fe catalyst, which is reported 16 mmol g⁻¹h⁻¹ at 0.9 MPa and 450° C. but much higher than the magnetite Fe-based industrial catalyst (1.7 mmol g⁻¹h⁻¹) (Table 1). Therefore, high activity for the SDC promoted Fe catalyst has been demonstrated, which is significantly higher than that of the industrial Fe-based catalyst.

The inventors propose that this improvement is related to the extrinsic oxygen vacancies deliberately introduced through the doping of Sm₂O₃ in CeO₂. For comparison, the activity of Fe catalyst promoted with 20 wt % CeO₂ was also measured at 3 MPa over the same range of temperatures (FIG. 20). It was observed that the activity of SDC promoted Fe is much higher than that of CeO₂ promoted Fe at temperatures above 350° C. This experiment clearly demonstrates that the introduction of extrinsic oxygen vacancies can significantly improve the catalytic activity of Fe catalysts at moderate temperature. At higher temperatures, the oxygen vacancies are activated providing active sites for the reaction thus, the activity of Fe-SDC catalyst is much higher due to the oxygen vacancy concentration of SDC being significantly greater than that for pure CeO₂.

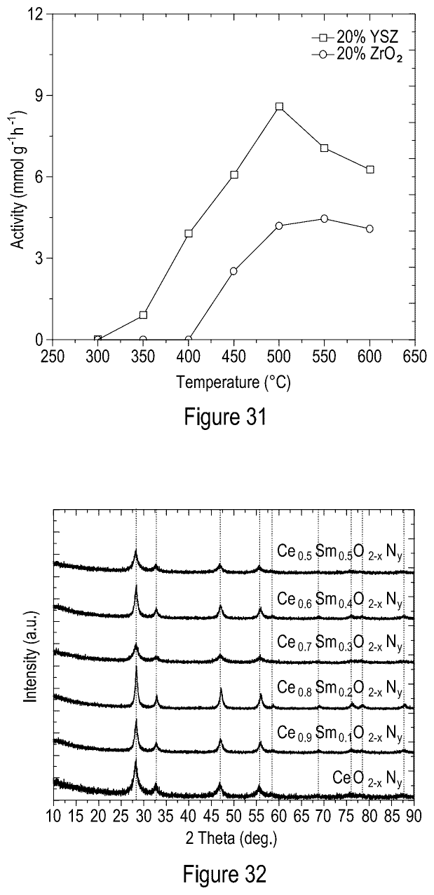

In order to further confirm the critical role extrinsic oxygen vacancies have on promoting the Fe-based catalyst, pure ZrO₂ and 8 mol % Y₂O₃-stabilized ZrO₂ (YSZ) were also used to promote Fe-based catalyst with the same 20 wt % weight ratio. Extrinsic oxygen vacancies are present in YSZ whist there are no extrinsic oxygen vacancies in ZrO₂. It was clearly observed that the activity of Fe—YSZ catalyst is much higher than that for Fe—ZrO₂ at temperatures above 300° C. (FIG. 31). This experiment further confirms that extrinsic oxygen vacancies have obvious promotion effects on the catalytic activity. It was observed that pure ZrO₂ also exhibits promotion effects at temperatures above 400° C. Similar to pure CeO₂, this is probably related to the formation of intrinsic oxygen vacancies when zirconium is exposed to hydrogen at high temperatures. It is well known that the reduction of CeO₂ is much easier than ZrO₂. Therefore under the same reducing condition, the oxygen vacancy concentration is much higher for CeO₂ and a higher catalytic activity is achieved. On the other hand, the reduction of CeO₂ will release electrons which can be donated to iron and then to the anti-bond of N═N of adsorbed N₂, facilitating the cleavage of N₂, increasing the NH₃ production rate.

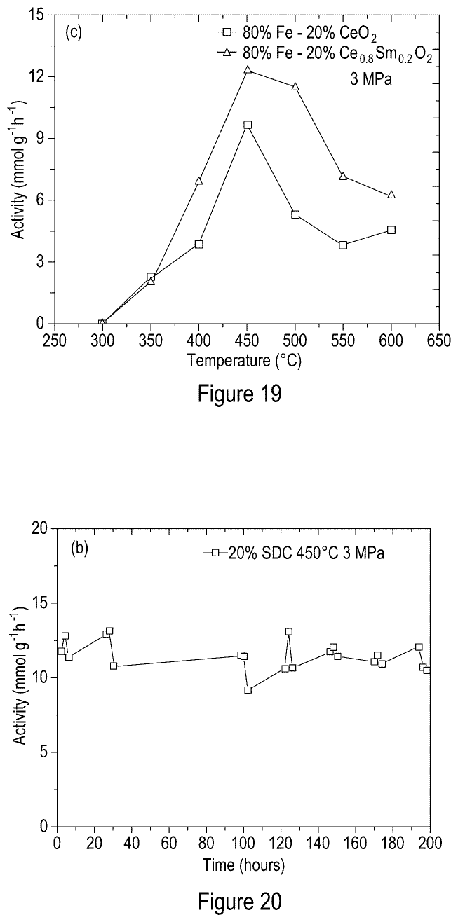

However, the reduction of SDC is much more difficult than that for CeO₂, in other words, under the ammonia synthesis conditions, the provided electrons from SDC will be a lot lower than that from CeO₂. Therefore the higher promotion effect observed from SDC is not due to the donation of electrons for cleavage of N₂, it is therefore mainly from the dissociation of H₂ through oxygen vacancies. It has been reported that H₂ adsorption is high between 400 and 500° C. but sharply decreases above 500° C. This is consistent with the peak activity for Fe—CeO₂ and Fe-SDC catalysts where the highest activity was at 450° C. and the 2^{nd} highest at 500° C. (FIGS. 17 and 19). Therefore, when investigating oxide promoters, the effect from H₂ dissociation is more important than that of electron donation. Both pure CeO₂ and SDC exhibit no catalytic activity towards ammonia synthesis when tested on their own without iron, indicating they cannot cleave N₂ by themselves. The cleavage must rely on iron. This provides further evidence that the promotion effect from SDC and YSZ is mainly from the extrinsic oxygen vacancies. To further confirm the promotion effect of extrinsic oxygen vacancies, commercial ZrO₂ and YSZ were also used to promote Fe-based catalyst. It was also observed from the obtained XRD patterns that complete reduction of Fe₂O₃ was achieved under reaction conditions. The formula of 8 mol % Y₂O₃ doped ZrO₂ is approximately Zr_{0.85}Y_{0.15}O_{2-δ}. The doping level in YSZ is lower than that for SDC, thus the concentration of extrinsic oxygen vacancies in YSZ is lower than that for SDC, leading to lower activity. On the other hand, a lot fewer electrons are provided from YSZ compared to SDC as reduction of the later is relatively easier. This has been demonstrated when they have been used as electrolytes for solid oxide fuel cells. Therefore, the promotion effect from SDC is more significant than that for YSZ. This increase in activity for both the ceria based and zirconia based promotors when the amount of extrinsic oxygen vacancies are increased provides clear evidence to the promotional effect of oxygen vacancies to the ammonia synthesis reaction.

The activities of each of the optimal compositions of catalyst at 450° C. and 3 MPa are highlighted in FIG. 22 along with the activity of an industrial iron catalyst under the same reaction conditions. From this it was observed that the activity of 80% Fe-20% SDC was nearly 3 times higher than that of a magnetite Fe-based industrial catalyst. The reduction in activity as the pressure was decreased was also less pronounced for the catalysts promoted by SDC. It is notable that the calcined catalyst (middle bars) has lower activity than the equivalent catalyst that has not been calcined. This supports the role of anionic vacancies in promoting the reaction.

Alongside the clear promotion effect of ceria and doped ceria towards the synthesis of ammonia with an iron catalyst, the resistance to catalyst poisoning should also be noted. The purity of both reaction gases used in our experiments was 99.995% with no further purification, both oxygen and water were present in the 50 ppm impurities. It can be seen that our measured activity for an industrially used commercial promoted Fe catalyst is lower than that reported elsewhere, this lower activity is an indicator of the negative effects of oxygenates in the feed gas in our experiment. However, the high activities obtained for the ceria and doped ceria supported catalyst indicate excellent tolerance towards impurities in the feed gas. As shown in FIG. 20, during the measured 200 hour test at 450° C. and 3 MPa, the 80% Fe-20% SDC is fairly stable although less pure H₂ and N₂ (99.995%) was used as the feeding gas. The catalyst is observed to keep its high activity over this period showing its resistance to gas feed impurities. The activity of our catalysts is comparable to the leading Fe-based industrial catalysts tested under extreme gas purity (99.99995%). It was observed that the activity measured at the start of each group during the 200 hours test was slightly lower than each of the others. This is due to the reactor needing time to achieve a stable through put after the flow rate was increased from 40 mL min⁻¹ to 80 mL min⁻¹ at the start of each group. This experiment indicates that the SDC promoted Fe catalyst has high oxygenate tolerance and ammonia can be continuously produced from less pure H₂ and N₂. This will reduce the requirement on H₂ and N₂ purification, saving the cost on equipment, purification catalysts and maintenance for the gas purification process. The energy input on the gas purification process will also be reduced thus increasing the overall efficiency. This feature is particularly useful when renewable electricity is used as the energy source for ammonia synthesis. Intensive purification on H₂ produced through the splitting of water and N₂ through the separation from air may not be required, making the localised ammonia synthesis process less complicated and more feasible.

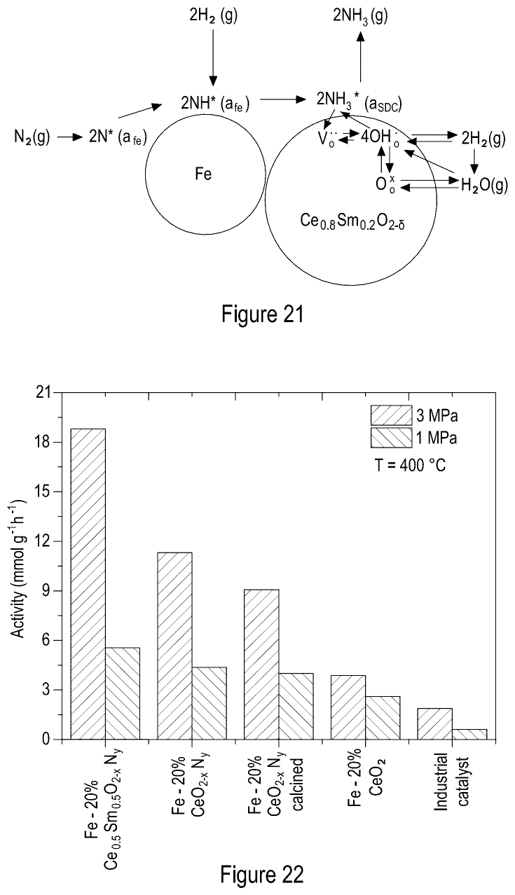

The mechanism in which oxygen poisons an ammonia synthesis catalyst occurs through the growth of large iron crystals formed through the continuous oxidation and reduction cycles that take place. CeO₂ based materials are excellent combustion catalysts. The presence of a CeO₂ based promoter in the composite catalysts will catalyse the reaction between H₂ and trace amounts of O₂, forming H₂O. The other oxygenates such as CO, H₂O can effectively adsorb on the surface of CeO₂-based materials. Without wishing to be bound by theory, under these conditions SDC is used as a reservoir to reversibly store oxygenates, thus decreasing the chance for oxidation of Fe causing the sintering of Fe to become less significant. H₂O from the reaction between the H₂ syngas and O₂ impurity, or the H₂O impurity itself will interact with oxygen vacancies to form protonic defects further reacting with NH* to form NH₃ (FIG. 21). This protection from large iron crystal growth through repeated oxygenation cycles is evident when examining the higher surface area exhibited by the catalysts promoted with SDC and YSZ after reduction. Therefore the negative effect of the oxygenates on Fe particles will be minimised, leading to good stability.

In brief, the addition of an oxide promoter with extrinsic oxygen vacancies, such as SDC or YSZ, to an iron catalyst has shown an improvement in both activity and gas impurity tolerance over the conventional fused iron catalysts, opening up an exciting new class of ammonia synthesis catalysts. This provides a new strategy to develop novel ammonia synthesis catalyst with both high activity and high tolerance to oxygenates for practical applications, particularly for low carbon ammonia synthesis using renewable electricity as the energy source.

### Example 3

i) Preparation of Fe—CeO₂₋ₓN_{y}

0.02 mol, 8.6844 g Ce(NO₃)₃·6H₂O was mixed with 0.2 mol, 12.012 g urea in a ceramic evaporating dish. Then 50 ml water was added into the mixture to dissolve the mixture. The ceramic evaporating dish was then put on a hotplate. This mixture was continuously stirred at 120° C. for 24 hours before increasing the temperature to 400° C. for combustion. The resulting gel like product was then combusted at 400° C. to obtain the powder product of CeO₂₋ₓN_{y}.

The obtained CeO₂₋ₓN_{y} powder was mixed with commercial Fe₂O₃ (Alfa) with weight ratio of 85/15 for Fe₂O₃:CeO₂₋ₓN_{y} to be used for ammonia synthesis. The loading of the composite catalysts was 300 mg after reduction to Fe:CeO₂₋ₓN_{y}. The H₂ and N₂ flow rates were 60 ml min⁻¹ and 20 ml min⁻¹ respectively at ambient temperature and pressure. The synthesised ammonia was collected by 100 ml (0.01 M) H₂SO₄ solution and was measured by a Fisher Scientific Orion A214 ammonia meter.

Nitrogen and the value of x and y were confirmed through XRF analysis. The results are given in the table below. This gives a composition of CeO_{1.42}N_{0.39} and CeO_{1.37}N_{0.42} before and after the stability test respectively.

In order to calculate the given composition it was assumed that Ce had a valance of +4, O a valance of −2, and N a valance of −3 with an overall charge of zero (neutrality). From this the following charge balance can be constructed.

(+4)(a)+(−2)(2−x)+(−3)(y)=0

Where a is the number of moles of Ce in the composition. For CeO₂₋ₓN_{y} a=1.

This gives:

$$x = \frac{3}{2} y$$

From the XRF data the value of y can be obtained through a direct mole ratio of N to Ce, allowing for x to be calculated from the above equation.

In order to confirm that all nitrogen observed in the XRF results was in the CeO₂₋ₓN_{y} composition, pure commercial CeO₂ was tested. It can be observed in table 2(c) that no nitrogen was present in the pure commercial CeO₂.

A significant amount of carbon as well as excess oxygen were detected in all XRF results for cerium samples including pure commercial CeO₂. This is due to the strong adsorption of CO₂ and CO on the CeO₂ surface at room temperature as has been reported elsewhere (C. Slostowski, S. Marrea, P. Dagaulta, O. Babotb, T. Toupanceb, C. Aymonier, Journal of CO₂ Utilization 20, 52-58 (2017), (8) I. Yanase, K. Suzuki, T. Ueda, H. Kobayashi, Materials Letters 228, 470-474 (2018)). No nitrogen signal was picked up from commercial CeO₂ indicating the adsorption of N₂ on the CeO₂ surface is negligible.

Due to the adsorption of CO₂ on the CeO₂ surface, extra signals of carbon and oxygen are shown in XRF measurements. Therefore the observed oxygen content is the sum of the oxygen from absorbed CO₂ and in those in the oxynitrides. Under the circumstance a direct measurement of oxygen content and y value cannot be directly obtained from the XRF results. However, the absorption of nitrogen on commercial CeO₂ is negligible, it is assumed that the adsorption of nitrogen on cerium oxynitride is also negligible. Therefore, the measured molar ratio between Ce and N will be accurate. From the Ce:N molar ratio, based on the charge neutrality principle for a molecule, the content of oxygen in cerium oxynitrides can be then deduced.

This gives a composition of CeO_{1.42}N_{0.39} and CeO_{1.37}N_{0.42} before and after the stability test respectively, i.e. Y=0.39 before and 0.42 after. The content of nitrogen in the cerium oxynitride increased a little, which means the oxynitride is stable under the ammonia synthesis condition.
ii) Preparation of Fe—Ce_{0.8}Sm_{0.2}O₂₋ₓN_{y}

0.016 mol, 6.9475 g Ce(NO₃)₃·6H₂O, 0.004 mol, 1.7778 g Sm(NO₃)₃·6H₂O and 0.2 mol, 12.012 g urea were mixed in a ceramic evaporating dish. Then 50 ml water was added to dissolve the mixture. The ceramic evaporating dish was then put on a hotplate. This mixture was continuously stirred at 120° C. for 24 hours before increasing the temperature to 400° C. The resulting gel like product was then combusted at 400° C. to obtain the powder product of Ce_{0.8}Sm_{0.2}O₂₋ₓN_{y}.

The obtained Ce_{0.8}Sm_{0.2}O₂₋ₓN_{y} powder was mixed with commercial Fe₂O₃ (Alfa) with weight ratio of 85/15 for Fe₂O₃:Ce_{0.8}Sm_{0.2}O₂₋ₓN_{y} to be used for ammonia synthesis. The loading of the composite catalysts was 300 mg after reduction to Fe:Ce_{0.8}Sm_{0.2}O₂₋ₓN_{y}. The H₂ and N₂ flow rates were 60 ml min⁻¹ and 20 ml min⁻¹ respectively at ambient temperature and pressure. The synthesised ammonia was collected by 100 ml (0.01 M) H₂SO₄ solution and was measured by a Fisher Scientific Orion A214 ammonia meter.

Nitrogen and the value of x and y were confirmed through XRF analysis. The results are given in the table below. This gives a composition of Ce_{0.799}Sm_{0.201}O_{1.541}N_{0.239} i.e. a=0.80, b=0.20, X=1.54 and Y=0.24. In order to calculate the given composition it was assumed that Ce had a valance of +4, Sm a valance of +3, O a valance of −2, and N a valance of −3 with a total composition charge of 0.

From this the following charge balance can be constructed.

(+4)(a)+(+3)(b)+(−2)(2−x)+(−3)(y)=0

Where a is the number of moles of Ce and b is the number of moles of Sm in the composition.

This gives:

$$x = \frac{3 y - 4 a - 3 b + 4}{2}$$

From the XRF data the value of y can be obtained through a direct mole ratio of N to Ce and Sm, allowing for x to be calculated from the above equation.
iii) Preparation of Fe—Ce_{0.5}Sm_{0.5}O₂₋ₓN_{y}

0.01 mol, 4.3422 g Ce(NO₃)₃·6H₂O, 0.01 mol, 4.4445 g Sm(NO₃)₃·6H₂O and 0.2 mol, 12.012 g urea were mixed in a ceramic evaporating dish. Then 50 ml water was added to dissolve the mixture. The ceramic evaporating dish was then put on a hotplate. This mixture was continuously stirred at 120° C. for 24 hours before increasing the temperature to 400° C. The resulting gel like product was then combusted at 400° C. to obtain the powder product of Ce_{0.5}Sm_{0.5}O₂₋ₓN_{y}.

The obtained Ce_{0.5}Sm_{0.5}O₂₋ₓN_{y} powder was mixed with commercial Fe₂O₃ (Alfa) with weight ratio of 85/15 for Fe₂O₃:Ce_{0.5}Sm_{0.5}O₂₋ₓN_{y} to be used for ammonia synthesis. The loading of the composite catalysts was 300 mg after reduction to Fe:Ce_{0.5}Sm_{0.5}O₂₋ₓN_{y}. The H₂ and N₂ flow rates were 60 ml min⁻¹ and 20 ml min⁻¹ respectively at ambient temperature and pressure. The synthesised ammonia was collected by 100 ml (0.01 M) H₂SO₄ solution and was measured by a Fisher Scientific Orion A214 ammonia meter.

Nitrogen and the value of x and y were confirmed through XRF analysis. This gives a composition of Ce_{0.49}Sm_{0.51}O_{0.51}N_{0.82} and Ce_{0.52}Sm_{0.48}O_{0.48}N_{0.86} before and after the stability test respectively, i.e. Y=0.82 before and 0.86 after. The content of nitrogen in the samarium doped cerium oxynitride increased a little, which means the oxynitride is stable under the ammonia synthesis conditions.

| | Specific surface |
|---|---|
| Sample | area (m² g⁻¹) |
| Fe₂O₃ | 36.541 |
| CeO₂₋ₓN_{y} | 21.574 |
| Fe₂O₃— CeO₂₋ₓN_{y} | 26.451 |
| Fe— CeO₂₋ₓN_{y} | 6.056 |
| Fe— CeO₂₋ₓN_{y} after | 7.386 |
| 200 hour stability test | |
| CeO₂ | 46.710 |
| Fe₂O₃— CeO₂ | 18.220 |
| Fe— CeO₂ | 5.499 |
| CeO₂₋ₓN_{y} calcined | 24.351 |
| Ce_{0.5}Sm_{0.5}O₂₋ₓN_{y} | 36.436 |
| Fe₂O₃— | 31.913 |
| Ce_{0.5}Sm_{0.5}O₂₋ₓN_{y} | |
| Fe— Ce_{0.5}Sm_{0.5}O₂₋ₓN_{y} | 7.022 |
| Fe— Ce_{0.5}Sm_{0.5}O₂₋ₓN_{y} | 5.796 |
| after 200 hour | |
| stability test | |

iv) CeₐSm_{b}O₂₋ₓN_{y}

CeO₂₋ₓN_{y} and CeₐSm_{b}O₂₋ₓN_{y} were synthesised from cerium nitrate, samarium nitrate and urea as described above.

| | Lattice | Composition from |
|---|---|---|
| Denoted composition | parameter a (Å) | XRF results |
| CeO₂₋ₓN_{y} | 5.4107(2) | CeO_{1.42}N_{0.39} |
| Ce_{0.9}Sm_{0.1}O₂₋ₓN_{y} | 5.4230(2) | Ce_{0.903}Sm_{0.097}O_{1.469}N_{0.322} |
| Ce_{0.8}Sm_{0.2}O₂₋ₓN_{y} | 5.4348(1) | Ce_{0.799}Sm_{0.201}O_{1.541}N_{0.239} |
| Ce_{0.7}Sm_{0.3}O₂₋ₓN_{y} | 5.4442(1) | Ce_{0.688}Sm_{0.322}O_{0.782}N_{0.718} |
| Ce_{0.6}Sm_{0.4}O₂₋ₓN_{y} | 5.4533(5) | Ce_{0.605}Sm_{0.395}O_{0.496}N_{0.871} |
| Ce_{0.5}Sm_{0.5}O₂₋ₓN_{y} | 5.4695(5) | Ce_{0.494}Sm_{0.506}O_{0.514}N_{0.822} |
| CeO₂₋ₓN_{y} calcined | | CeO_{1.67}N_{0.22} |
| CeO₂₋ₓN_{y} promotor | | CeO_{1.37}N_{0.42} |
| after stability | | |

It can be observed that the calcination (heating in air) increases the proportion of oxygen and decreases the proportion of nitrogen whereas this is not observed during stability testing under Haber-Bosch conditions (hydrogen and nitrogen atmosphere). This is believed to be due to the presence of a large amount of N₂ in the precursors whilst the oxygen partial pressure is much lower than that in air.

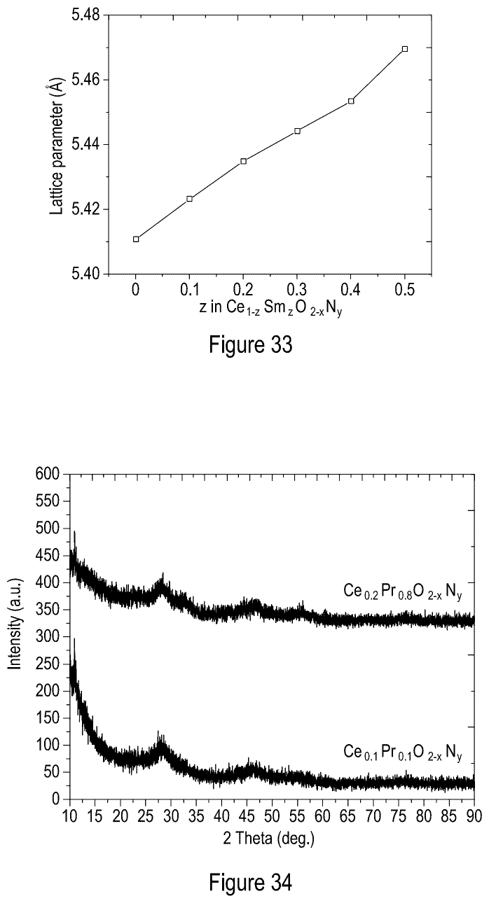

XRD patterns of pure and Sm-doped CeO₂₋ₓN_{y} are similar to CeO₂ (FIG. 32). Without being bound by theory, the inventors propose that these oxynitrides have the same or similar structure to CeO₂. The indexed lattice parameters of these oxynitrides were obtained (FIG. 33): the lattice parameter increases with the increased Sm doping level and the trend follows Vegard's law. This indicates that all of the investigated oxynitrides are likely to be single phases, rather than a mixture. Pure CeO₂ exhibits cubic fluorite structure. In the fluorite structure, the coordination numbers (CNs) for the cation and anion are 8 and 4 respectively. The ionic size of Ce⁴⁺ and Sm³⁺ ions at CN=8 is 0.97 Å and 1.079 Å respectively. Therefore, the doping of larger Sm³⁺ ions is believed to explain the increased lattice parameters of CeₐSm_{b}O₂₋ₓN_{y}. The existence of nitrogen defects and oxygen vacancies in the oxynitrides may also affect the lattice parameters but the effect of Sm-doping is more significant.

Raman spectra for oxide and oxynitride samples were recorded on a Renishaw inVia Reflex Raman Microscope (Gonzo) equipped with DPSS laser at an excitation wavelength λ=532 nm, using ×5 objective and Renishaw CCD detector.

Raman spectra of these samples were also collected and plotted (FIG. 30). Pure CeO₂, raw and calcined CeO₂₋ₓN_{y} show a sharp F2 g peak at 465 cm⁻¹, which corresponds to the typical fluorite structure of CeO₂. A peak at 570 cm⁻¹ is attributed to oxygen vacancies.

At 570 cm⁻¹, no peak was observed for pure CeO₂ and calcined CeO₂₋ₓN_{y} indicating low oxygen vacancies in these samples. The peak for raw CeO₂₋ₓN_{y} and Ce_{0.9}Sm_{0.1}O₂₋ₓN_{y} at 570 cm⁻¹ is very weak, which is attributed to a low concentration of oxygen vacancies.

With increased Sm doping level, this peak becomes stronger indicating higher concentration of oxygen vacancies. Sample Ce_{0.5}Sm_{0.5}O₂₋ₓN_{y} has the highest doping level and the peak at 570 cm⁻¹ is also the strongest. This experiment demonstrates there are a large number of oxygen vacancies in the Sm-doped cerium oxynitrides, particularly at high doping level.

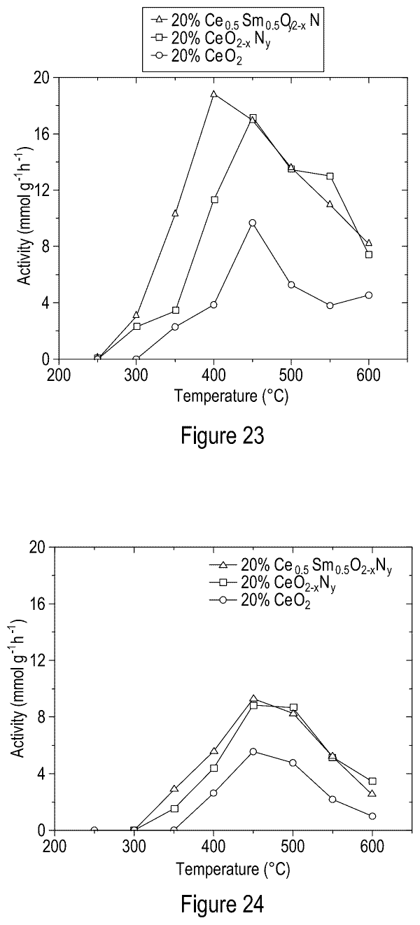

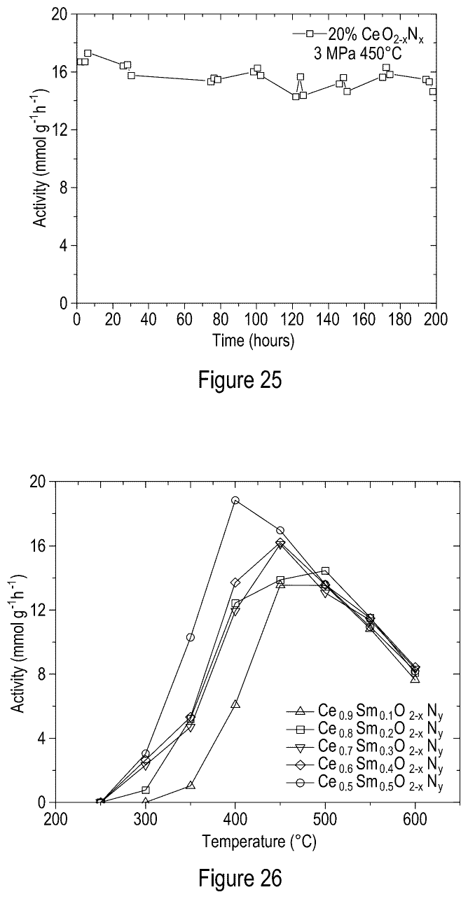

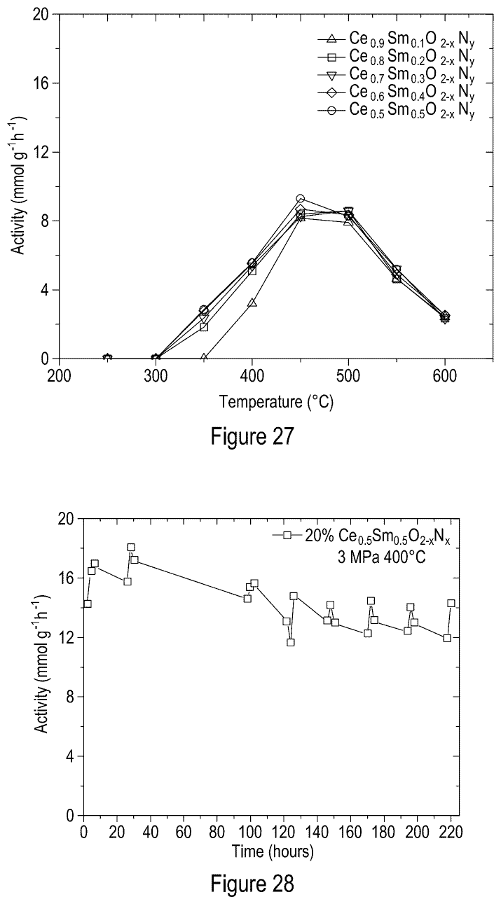

FIGS. 23 and 24 demonstrate that Ce_{0.5}Sm_{0.5}O₂₋ₓN_{y} has greater activity than Fe—CeO₂ and Fe—CeO₂₋ₓN_{y}. The activities of the following CeₐSm_{b}O₂₋ₓN_{y} catalysts are shown in FIGS. 26 and 27 at 3 MPa and 1 MPa respectively:
Ce_{0.9}Sm_{0.1}O₂₋ₓN_{y}
Ce_{0.8}Sm_{0.2}O₂₋ₓN_{y}
Ce_{0.7}Sm_{0.3}O₂₋ₓN_{y}
Ce_{0.6}Sm_{0.4}O₂₋ₓN_{y}
Ce_{0.5}Sm_{0.5}O₂₋ₓN_{y}

In general, sample Ce_{0.5}Sm_{0.5}O₂₋ₓN_{y}, with the measured composition of Ce_{0.49}Sm_{0.51}O_{0.51}N_{0.82} exhibits the highest activity. The possible reason is that, it has the highest concentration of anion vacancies. About ⅓ of the anion sites are vacant. This reactant nitrogen may have strong interaction with these anion vacancies to facilitate the reaction between N₂ and Hz, forming ammonia. As expected, the activity at 3 MPa (FIG. 26) is much high than the activity at 1 MPa (FIG. 27).

The results for the stability test of Fe—Ce_{0.5}Sm_{0.5}O₂₋ₓN_{y} at 3 MPa and 400° C. are shown in FIG. 28. After the initial slow decrease of the activity at the first 120 hours, the catalyst became stable until the measured 220 hours.
v) Preparation of praseodymium doped cerium oxynitrides CeₐPr_{b}O₂₋ₓN_{y} and 85% Fe₂O₃: 15% Ce_{0.2}Pr_{0.8}O₂₋ₓN_{y}

Ce_{0.1}Pr_{0.9}O₂₋ₓN_{y}, Ce_{0.2}Pr_{0.8}O₂₋ₓN_{y}, Ce_{0.5}Pr_{0.5}O₂₋ₓN_{y} and Ce_{0.8}Pr_{0.2}O₂₋ₓN_{y} were synthesised from cerium nitrate, praseodymium nitrate and urea analogous to the method described below for Ce_{0.2}Pr_{0.8}O₂₋ₓN_{y} with adjusted molar ratio for cerium to praseodymium for each sample. The oxynitrides were found to exist as a single phase, rather than a mixture (see FIG. 33).

0.0046 mol Ce(NO₃)₃·6H₂O, 0.0184 mol Pr(NO₃)₃·6H₂O and 0.23 mol urea were mixed in a ceramic evaporating dish. Then 50 ml water was added to dissolve the mixture. The ceramic evaporating dish was then put on a hotplate. This mixture was continuously stirred at 120° C. for 24 hours before increasing the temperature to 400° C. The resulting gel like product was then combusted at 400° C. to obtain the powder product of Ce_{0.2}Pr_{0.8}O₂₋ₓN_{y}.

The obtained Ce_{0.2}Pr_{0.8}O₂₋ₓN_{y} powder was mixed with commercial Fe₂O₃ (Alfa) with weight ratio of 85/15 for Fe₂O₃:Ce_{0.2}Pr_{0.8}O₂₋ₓN_{y} to be used for ammonia synthesis. The loading of the composite catalysts was 300 mg after reduction to Fe:Ce_{0.2}Pr_{0.8}O₂₋ₓN_{y}. The H₂ and N₂ flow rates were 60 ml min⁻¹ and 20 ml min⁻¹ respectively at ambient temperature and pressure. The synthesised ammonia was collected by 100 ml (0.01 M) H₂SO₄ solution and was measured by a Fisher Scientific Orion A214 ammonia meter.
vi) Preparation of Ru—Ce_{0.5}Sm_{0.5}O₂₋ₓN_{y}

0.01 mol, 4.3422 g Ce(NO₃)₃·6H₂O, 0.01 mol, 4.4445 g Sm(NO₃)₃·6H₂O and 0.2 mol, 12.012 g urea were mixed in a ceramic evaporating dish. Then 50 ml water was added to dissolve the mixture. The ceramic evaporating dish was then put on a hotplate. This mixture was continuously stirred at 120° C. for 24 hours before increasing the temperature to 400° C. The resulting gel like product was then combusted at 400° C. to obtain the powder product of Ce_{0.5}Sm_{0.5}O₂₋ₓN_{y}.

0.1054 g Ru₃C₁₂O₁₂ (Alfa 99%) was dissolved in 50 mL of tetrahydrofuran (Fisher 99.5%) and continuously stirred for 4 hours. 0.450 g Ce_{0.5}Sm_{0.5}O₂₋ₓN_{y} powder was added to this solution and continuously stirred for 24 hours. Tetrahydrofuran was evaporated at room temperature and the obtained composite catalyst powder was loaded in to the reactor to give a loading of 0.300 g after reduction to Ru—Ce_{0.5}Sm_{0.5}O₂₋ₓN_{y} with a weight ratio of 10/90 respectively. The H₂ and N₂ flow rates were 60 ml min⁻¹ and 20 ml min⁻¹ respectively at ambient temperature and pressure. The synthesised ammonia was collected by 100 ml (0.01 M) H₂SO₄ solution and was measured by a Fisher Scientific Orion A214 ammonia meter. The catalytic activity was carried out after reducing the Ru—Ce_{0.5}Sm_{0.5}O₂₋ₓN_{y} catalyst in the mixture of N₂/H₂ (molar ratio 1:3) at 450° C. for overnight.

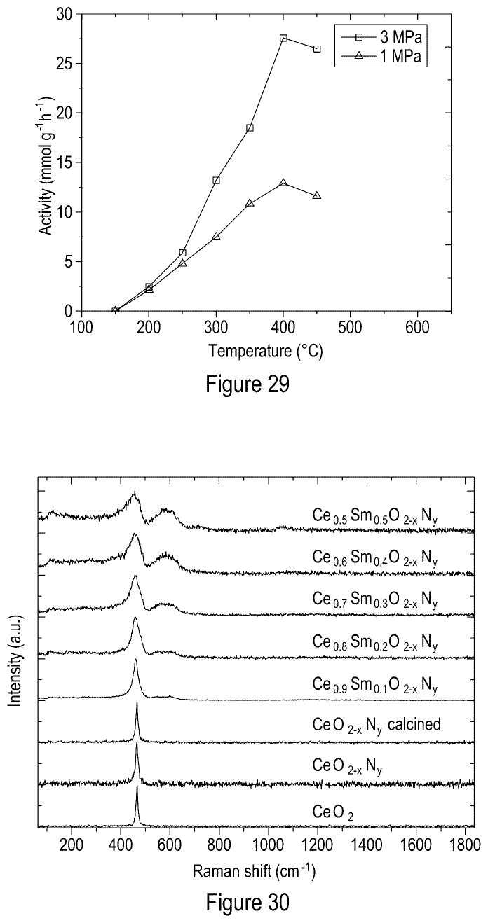

The activities of Ru—Ce_{0.5}Sm_{0.5}O₂₋ₓN_{y} at 30 bar and 10 bar under different reaction temperatures are shown in FIG. 29. At the 3 MPa, the activity of Ru—Ce_{0.5}Sm_{0.5}O₂₋ₓN_{y} is much higher than that for Fe—Ce_{0.5}Sm_{0.5}O₂₋ₓN_{y} although the weight ratio is different. The Ru catalyst promoted by oxynitride Ce_{0.5}Sm_{0.5}O₂₋ₓN_{y} is still active at a temperature as low as 200° C. whilst under the same pressure, the Fe-based catalysts do not show good activity at a temperature of 300° C. This indicates that materials with anion vacancies such as oxynitrides are excellent promoters for Ru catalyst as well. As the cost of Ru catalyst is high, one of the strategies is to introduce a small amount of Ru (less than 20 wt %, ideally less than 5 wt % of the total weight) Ru into the low-cost Fe-based catalyst promoted by materials with anion vacancies, typically oxynitrides, such as Ce_{0.5}SM_{0.5}O₂₋ₓN_{y} in order to achieve both low-cost and high activity.

1. A product comprising an anion vacant lattice and a Haber-Bosch catalyst, wherein the anion vacant lattice comprises doped ZrO₂, doped TiO₂, doped BaZrO₃, a compound according to formula V, a compound according to formula VI, or a combination thereof:
ZrₐM_{b}O₂₋ₓN_{y} (Formula V)
wherein M is titanium; and/or cerium; and/or one or more elements with a valence lower than 4, “a” and “b” are independently in the range 0.05 to 0.95, with the proviso that “a” and “b” together approximately sum to 1; 0<X<2; and 0<Y<X
TiₐM_{b}O_{2-X}N_{Y} (Formula VI)
wherein M is zirconium; and/or cerium; and/or one or more elements with a valence lower than 4, “a” and “b” are independently in the range 0.05 to 0.95, with the proviso that “a” and “b” together approximately sum to 1; 0<X<2; and 0<Y≤X.

2. The product according to claim 1, wherein the Haber-Bosch catalyst comprises a metal selected from the group consisting of: Fe, Co, Ni, Ru, or combinations thereof.

3-8. (canceled)

9. The product according to claim 1, wherein the anion vacant lattice is a compound according to formula V or formula VI.

10. The product according to claim 1, wherein the anion vacant lattice is doped ZrO₂, doped TiO₂, doped BaZrO₃ or combinations thereof.

11. The product according to claim 10, wherein the anion vacant lattice is yttrium stabilized zirconia (YSZ).

12-14. (canceled)

15. The product according to claim 9, wherein the anion vacant lattice is a compound according to formula I:
BaZrₓCe_{y}Y_{z}O_{3-δ} (Formula I)
wherein, each of x, y and z are independently in the range 0.05 to 0.95, with the proviso that x, y and z together sum to 1.

16. The product according to claim 15, wherein each of “x”, “y” and “z” are independently in the range 0.1 to 0.8.

17. The product according to claim 16, wherein the anion vacant lattice is BaZr_{0.1}Ce_{0.7}Y_{0.2}O_{3-δ}.

18. (canceled)

19. A process for producing ammonia, the process comprising the steps of:
i) providing a product according to claim 1; and
ii) exposing said product to a mixture of nitrogen and hydrogen gas.

20. The process of claim 19, wherein exposing said product to a mixture of nitrogen and hydrogen is performed at a temperature below 600° C. and a pressure below 20 MPa and/or the process is a batch process.

21. (canceled)

22. An anion vacant lattice according to formula V or formula VI:
ZrₐM_{b}O_{2-X}N_{Y} (Formula V)
wherein M is titanium; and/or cerium; and/or one or more elements with a valence lower than 4, “a” and “b” are independently in the range 0.05 to 0.95, with the proviso that “a” and “b” together approximately sum to 1; 0<X<2; and 0<Y≤X
TiₐM_{b}O_{2-X}N_{Y} (Formula VI)
wherein M is zirconium; and/or cerium; and/or one or more elements with a valence lower than 4, “a” and “b” are independently in the range 0.05 to 0.95, with the proviso that “a” and “b” together approximately sum to 1; 0<X<2; and 0<Y≤X.

23. The anion vacant lattice according to claim 22, wherein (i) M is Sm, Pr and/or La; and (ii) a is from 0.1 to 0.9.
